(19) United States
(12) Patent Application Publication
(10) Pub. No.: US 2013/0324691 A1
(43) Pub. Date: Dec. 5, 2013

(54) Ethylene-a-Olefin Copolymer and Article

(71) Applicant: Yoshinobu Nozue, Chuo-ku (JP)

(72) Inventor: Yoshinobu Nozue, Chuo-ku (JP)

(73) Assignee: SUMITOMO CHEMICAL COMPANY, LIMITED, Chuo-ku, Tokyo (JP)

(21) Appl. No.: 13/984,949

(22) PCT Filed: Feb. 21, 2012
(86) PCT No.: PCT/JP2012/054687

§ 371 Date: Aug. 12, 2013

(30) Foreign Application Priority Data
Feb. 25, 2011 (JP) 2011-039474

(51) Int. Cl. C08F 210/16

(52) U.S. Cl. CPC C08F 210/16
USPC 526/348.4

(57) ABSTRACT

The present invention rerates to an ethylene-α-olefin copolymer comprising monomer units derived from ethylene and monomer units derived from an α-olefin having 3 to 20 carbon atoms, wherein the ethylene-α-olefin copolymer has a density of 860 to 950 kg/m³, a melt flow rate of 0.1 to 20.0 g/10 minutes, a ratio of a weight average molecular weight to a number average molecular weight measured by gel permeation chromatography of 2.0 to 3.5, a swell ratio of 2.0 to 2.8, and an activation energy of flow of 31.0 to 35.0 kJ/mol.

### TECHNICAL FIELD

The present invention relates to ethylene-α-olefin copolymers and articles obtained by extruding the ethylene-α-olefin copolymers.

### BACKGROUND ART

Ethylene-α-olefin copolymer have been molded into films, sheets, bottles, and so on by various molding techniques and have been used for various applications such as food wrapping materials.

Ethylene-α-olefin copolymers produced via polymerization using metallocene catalysts are known to be superior in mechanical strength such as impact strength and tensile strength. For this reason, articles can be expected to be reduced in weight and in cost by reduction in thickness of the articles while their mechanical strength is maintained, and accordingly such copolymers are currently considered to be used for various applications. However, ethylene-α-olefin copolymers produced via polymerization using conventional metallocene catalysts are not sufficient in molding processability because of their high extrusion load at the time of extrusion and their low melt tension and swell ratio, and therefore they are of limited utility.

As a countermeasure thereto, novel metallocene catalysts have recently been studied and ethylene-α-olefin copolymers obtained via polymerization of ethylene with an α-olefin using the catalysts and improved in molding processability have been proposed. For example, JP-A-2006-2098 discloses an ethylene-α-olefin copolymer obtained by polymerizing ethylene and an α-olefin using a transition metal compound having a ligand with three indenyl skeletons, a transition metal compound having a group having a ligand with three benzoindenyl skeletons, and a cocatalyst component for activation. JP-A-2005-206777 discloses an ethylene-α-olefin copolymer obtained by polymerizing ethylene and an α-olefin in the presence of a metallocene catalyst composed of a transition metal compound having a ligand with two non-bridged cyclopentadiene type anion skeletons and a transition metal compound having a ligand in which a group with a cyclopentadiene type anion skeleton and a group with a fluorenyl type anion skeleton are linked via a bridging group, a modified clay compound, and organoaluminum.

However, the ethylene-α-olefin copolymer disclosed in JP-A-2006-2098 is still insufficient in swell ratio. In addition, the copolymer is high in activation energy of flow. This suggests that the copolymer has many long chain branches, and accordingly it is thought that the mechanical strength of the copolymer is low. The ethylene-α-olefin copolymer disclosed in JP-A-2005-206777 is still insufficient in swell ratio and also insufficient in melt tension of the molecular chain of the ethylene-α-olefin copolymer melted. Therefore, the take-up property at the time of processing the copolymer and the appearance of an article obtained by processing the copolymer have been not sufficiently satisfactory.

Under such situations, the problem to be solved by the present invention is to provide an ethylene-α-olefin copolymer being high in melt tension and swell ratio and also high in mechanical strength, and an article obtained by extruding the copolymer.

### DISCLOSURE OF THE INVENTION

The first aspect of the present invention relates to an ethylene-α-olefin copolymer having monomer units derived from ethylene and monomer units derived from an α-olefin having 3 to 20 carbon atoms, wherein the ethylene-α-olefin copolymer has a density of 860 to 950 kg/m³, a melt flow rate of 0.1 to 20.0 g/10 minutes, a ratio of a weight average molecular weight to a number average molecular weight measured by gel permeation chromatography of 2.0 to 3.5, a swell ratio of 2.0 to 2.8, and an activation energy of flow of 31.0 to 35.0 kJ/mol.

The second aspect of the present invention relates to articles obtained by extruding the above-mentioned ethylene-α-olefin copolymers.

### MODE FOR CARRYING OUT THE INVENTION

The ethylene-α-olefin copolymer of the present invention is an ethylene-α-olefin copolymer comprising monomer units derived from ethylene and monomer units derived from an α-olefin having 3 to 20 carbon atoms. Examples of the α-olefin include propylene, 1-butene, 1-pentene, 1-hexene, 1-heptene, 1-octene, 1-nonene, 1-decene, 1-dodecene, 4-methyl-1-pentene, and 4-methyl-1-hexene, and these may be used alone or two or more members thereof may be used together. A preferable α-olefin is an α-olefin selected from among 1-butene, 1-hexene, 4-methyl-1-pentene, and 1-octene.

The ethylene-α-olefin copolymer of the present invention may have monomer units derived from other monomers in addition to the monomer units derived from ethylene and the monomer units derived from the α-olefin having 3 to 20 carbon atoms as far as the effect of the present invention is not impaired. Examples of such other monomers include conjugated dienes (e.g., butadiene and isoprene), non-conjugated dienes (e.g., 1,4-pentadiene), acrylic acid, acrylic acid esters (e.g., methyl acrylate and ethyl acrylate), methacrylic acid, methacrylic acid esters (e.g., methyl methacrylate and ethyl methacrylate), and vinyl acetate.

The content of the monomer units derived from ethylene in the ethylene-α-olefin copolymer of the present invention is usually 50 to 99.5% by weight where the overall weight of the ethylene-α-olefin copolymer is taken as 100% by weight. The content of the monomer units derived from an α-olefin is usually 0.5 to 50% by weight where the overall weight of the ethylene-α-olefin copolymer is taken as 100% by weight.

The ethylene-α-olefin copolymer of the present invention is preferably a copolymer comprising monomer units derived from ethylene and monomer units derived from an α-olefin having 4 to 20 carbon atoms, more preferably a copolymer comprising monomer units derived from ethylene and monomer units derived from an α-olefin having 5 to 20 carbon atoms, and even more preferably a copolymer comprising monomer units derived from ethylene and monomer units derived from an α-olefin having 6 to 8 carbon atoms.

Examples of the ethylene-α-olefin copolymer of the present invention include ethylene-1-butene copolymers, ethylene-1-hexene copolymers, ethylene-4-methyl-1-pentene copolymers, ethylene-1-octene copolymers, ethylene-1-butene-1-hexene copolymers ethylene-1-butene-4-methyl-1-pentene copolymers, ethylene-1-butene-1-octene copolymers, and ethylene-1-hexene-1-octene copolymers; ethylene-1-hexene copolymers, ethylene-4-methyl-1-pentene copolymers, ethylene-1-butene-1-hexene copolymers, ethylene-1-butene-1-octene copolymers, and ethylene-1-hexene-1-octene copolymers are preferred.

The density (hereinafter may be indicated as “d”) of the ethylene-α-olefin copolymer of the present invention is 860 to 950 kg/m³. From the viewpoint of increasing the mechanical strength of an article to be obtained, it is preferably not more than 940 kg/m³, more preferably not more than 930 kg/m³, and even more preferably not more than 925 kg/m³. From the viewpoint of increasing the stiffness of an article to be obtained, it is preferably not less than 870 kg/m³, more preferably not less than 880 kg/m³, even more preferably not less than 890 kg/m³, and particularly preferably not less than 900 kg/m³. The density is measured in accordance with Method A provided in JIS K7112-1980 after doing the annealing disclosed in JIS K6760-1995. The density of an ethylene-α-olefin copolymer can be changed by the content of the monomer units derived from ethylene in the ethylene-α-olefin copolymer.

The melt flow rate (hereinafter sometimes described as “MFR”) of the ethylene-α-olefin copolymer of the present invention is usually 0.1 to 20.0 g/10 min. From the viewpoint of reducing the extrusion load at the time of molding, the melt flow rate is preferably not less than 0.4 g/10 min, more preferably not less than 0.7 g/10 min, and most preferably not less than 1.0 g/10 min. From the viewpoint of increasing the mechanical strength of an article to be obtained, it is preferably not more than 10 g/10 min, more preferably not more than 5 g/10 min, even more preferably not more than 3 g/10 min, and most preferably not more than 2 g/10 min. The melt flow rate is a value measured by Method A under conditions represented by a temperature of 190° C. and a load of 21.18 N in the method provided in JIS K7210-1995. The melt flow rate of the ethylene-α-olefin copolymer can be changed, for example, by a hydrogen concentration or a polymerization temperature in the below-described method for producing the copolymer, and as a hydrogen concentration or a polymerization temperature is raised, the melt flow rate of the ethylene-α-olefin increases.

It is preferable that the ethylene-α-olefin copolymer of the present invention exhibits a single peak on a molecular weight distribution curve produced by gel permeation chromatography (GPC). When multimodal peaks are exhibited on a molecular weight distribution curve, the molecular weight distribution is broad. Since a copolymer being broad in molecular weight distribution contains much low molecular weight components, the copolymer is reduced mechanical strength.

The ratio (hereinafter sometimes indicated as “Mw/Mn”) of the weight average molecular weight (hereinafter sometimes indicated as “Mw”) to the number average molecular weight (hereinafter sometimes indicated as “Mn”) of the ethylene-α-olefin copolymer of the present invention is from 2.0 to 3.5. If the Mw/Mn is excessively large, the mechanical strength of an article to be obtained may become low. The Mw/Mn is preferably not more than 3.0. The Mw/Mn can be varied by appropriately choosing the types of a transition metal compound (A1) and a transition metal compound (A2) to be used for the production of the copolymer and their mixing ratio.

The ratio (hereinafter sometimes indicated as “Mz/Mw”) of the Z average molecular weight (hereinafter sometimes indicated as “Mz”) to Mw represents the molecular weight distribution of high molecular weight components contained in a polymer. That the Mz/Mw is smaller as compared with the Mw/Mn means that the molecular weight distribution of the high molecular weight components contained in the polymer is narrow and there are less components being very high in molecular weight, i.e., components being very long in relaxation time. That the Mz/Mw is larger as compared with the Mw/Mn means that the molecular weight distribution of the high molecular weight components contained in the polymer is broad and there are much components being very high in molecular weight, i.e., components being very long in relaxation time. The ethylene-α-olefin copolymer of the present invention is a copolymer appropriately controlled in the amount of high molecular weight components contained therein in terms of the balance between strength and processability, and (Mz/Mw)−(Mw/Mn) is preferably within the range of from −0.1 to 3.0, and more preferably within the range of from 0.0 to 0.5. The (Mz/Mw)−(Mw/Mn) can be varied by, for example, the usage ratio of the transition metal compound (A1) and the transition metal compound (A2) to be used for the production of the copolymer; as the usage ratio of the transition metal compound (A2) is increased, the (Mz/Mw)−(Mw/Mn) of the ethylene-α-olefin copolymer becomes larger. Since the mechanical strength of a copolymer will become lower if the value of Mz/Mw itself becomes larger, a preferable range of the Mz/Mw of the ethylene-α-olefin copolymer of the present invention is from 2.0 to 4.0, and more preferably from 2.5 to 3.5.

The swell ratio (hereinafter sometimes indicated as “SR”) of the ethylene-α-olefin copolymer of the present invention is 2.0 to 2.8. When the swell ratio is excessively small, the melt elasticity is low and failures may occur in processing, for example, great neck-in may occur in flat die film process. The swell ratio is preferably not less than 2.1, and more preferably not less than 2.2. The swell ratio is preferably not more than 2.5 from the viewpoint of improving the take-up property in extrusion. The swell ratio is a value (D/D₀) obtained by cooling in air a strand of an ethylene-α-olefin copolymer extruded in a length of about 15 to 20 mm through an orifice under conditions including a temperature of 190° C. and a load of 21.18 N during the measurement of an MFR, measuring the diameter D (unit: mm) of the strand at a position of about 5 mm away from the tip on the extrusion upstream side, and dividing the diameter D by the orifice diameter 2.095 mm (D₀). The SR of an ethylene-α-olefin copolymer is measured using a sample prepared by kneading the copolymer with a roll at 150° C. for 5 minutes. The swell ratio can be varied with the usage ratio of the transition metal compound (A1) and the transition metal compound (A2) to be used for the production of the copolymer; if the usage ratio of the transition metal compound (A2) is increased, the swell ratio of the ethylene-α-olefin copolymer will become larger. The swell ratio can be controlled by modifying the procedure to bring catalyst components into contact with each other when forming a catalyst.

The number of branches having five or more carbon atoms (hereinafter sometimes indicated as “N_{LCB}”) of the ethylene-α-olefin copolymer of the present invention is preferably less than 0.05/1000 C from the viewpoint of enhancing the mechanical strength of an article to be obtained. N_{LCB} is the number of branches having 5 or more carbon atoms which a copolymer contains per 1000 carbon atoms constituting the copolymer. N_{LCB} can be adjusted by, for example, choosing a transition metal compound (A1) of suitable structure in the method for producing the copolymer.

N_{LCB} is obtained by measuring the area of a peak derived from methine carbon having a branch of 5 or more carbon atoms bonded thereto from a ¹³C-NMR spectrum measured by the carbon nuclear magnetic resonance (¹³C-NMR) method, where the sum of the areas of all peaks observed at 5 to 50 ppm is taken as 1000. The peak derived from methine carbon having a branch of 5 or more carbon atoms bonded thereto is observed at approximately 38.2 ppm (see academic literature “Macromolecules”, USA, American Chemical Society, 1999, Vol. 32, pages 3817-3819). Since a position of this peak derived from methine carbon to which a branch having 5 or more carbon atoms is attached, is shifted depending on a measurement apparatus and measurement condition in some cases, usually, the position is determined by performing measurement of an authentic sample for every measurement apparatus and measurement condition. For spectral analysis, it is preferable to use a negative exponential function as a window function.

g* is a measure that indicates the degree of shrinkage of a molecule in a solution caused by long chain branches. When the content of long chain branches per molecular chain is large, the shrinkage of molecular chains becomes large and g* becomes small. As to the ethylene-α-olefin copolymer of the present invention, the g* defined by the following formula (II) is preferably 0.85 to 1.0, and more preferably 0.88 to 0.95 from the viewpoint of increasing mechanical strength. (With regard to g*, the following documents were referred to: Developments in Polymer Characterisation-4, J. V. Dawkins, Ed., Applied Science, London, 1983, Chapter I “Characterization of Long Chain Branching in Polymers” written by Th. G. Scholte.)

g*=/([η]/([η]_{GPC}×g_{SCB}*) (II)

wherein [η] represents the intrinsic viscosity (unit: dl/g) of the ethylene-α-olefin copolymer and is defined by the following formula (II-I); [η]_{GPC} is defined by the following formula (II-II); g_{SCB}* is defined by the following formula (II-III);

[η]=23.3×log(ηrel) (II-I)

wherein ηrel represents the relative viscosity of the ethylene-α-olefin copolymer;

[η]_{GPC}=0.00046×Mv^{0.725} (II-II)

wherein Mv represents the viscosity average molecular weight of the ethylene-α-olefin copolymer;

g_{SCB}*=(1−A)^{1.725} (II-III)

wherein A can be determined directly from the measurement of the content of short chain branches in the ethylene-α-olefin copolymer.

[η]_{GPC} represents the intrinsic viscosity (unit: dl/g) of a polymer, the molecular weight distribution of which is assumed to be the same as that of the ethylene-α-olefin copolymer, and the molecular chains of which are assumed to be linear.

g_{SCB}* represents the contribution to g* which is generated by the introduction of short chain branches into the ethylene-α-olefin copolymer.

Formula (II-II) was quoted from the formula disclosed in Journal of Polymer Science, 36, 130 (1959), pages 287-294 written by L. H. Tung.

The relative viscosity (ηrel) of an ethylene-α-olefin copolymer is measured by the following method. A sample solution is prepared by dissolving 100 mg of the copolymer at 135° C. in 100 ml of tetralin solution containing 0.5% by weight of butylhydroxytoluene (BHT) as a heat degradation inhibitor. Then, a fall time is measured for the sample solution and a blank solution consisting of a tetralin solution containing only 0.5% by weight of PHI by the use of an Ubbelohde type viscometer, and then from the results is calculated the relative viscosity.

The viscosity average molecular weight (Mv) of an ethylene-α-olefin copolymer is defined by the lower formula (II-IV). a=0.725.

$${M}_{V} = {( \frac{{\sum }_{μ = 1}^{∞} {M}_{μ}^{α + 1} {n}_{μ}}{{\sum }_{μ = 1}^{∞} {M}_{μ} {n}_{μ}} )}^{1 / a} \qquad ( II \text{-} IV )$$

The A in the formula (II-III) was calculated from the following formula.

A=((12×n+2n+1)×y)/((1000−2y−2)×14+(y+2)×15+y×13)

n represents the number of branched carbon atoms of short chain branches. For example, in the use of butene as an α-olefin, n=2, and in the use of hexene, n=4. y is the number of short chain branches per 1,000 carbon atoms determined by NMR or infrared spectroscopy.

The activation energy of flow (hereinafter sometimes indicated as “Ea”) of the ethylene-α-olefin copolymer of the present invention is 31.0 to 35.0 kJ/mol. If Ea is lower than 31.0 kJ/mol, then processability will deteriorate. On the other hand, if Ed is higher than 35.0 kJ/mol, then the mechanical strength of an article will deteriorate. The activation energy of flow can be varied by the ratio of the transition metal compound (A1) and the transition metal compound (A2) to be used for the production of a copolymer.

Ea is a numerical value calculated using an Arrhenius type equation from the shift factor in the preparation of a master curve showing the dependency of melting complex viscosity (unit: Pa·sec) on angular frequency (unit: rad/sec) at 190° C. on the basis of the temperature-time superposition principle, and is a value obtained by the method as described below. Specifically, with regard to temperatures of 130° C., 150° C., 170° C., and 190° C., a shift factor (a_{T}) at each temperature (T) is obtained by superposing melting complex viscosity-angular frequency curves of an ethylene-α-olefin copolymer at the respective temperatures (T, unit: ° C.) on the melting complex viscosity-angular frequency curve of the ethylene-based copolymer at 190° C. on the basis of the temperature-time superposition principle. Then, a linear approximate equation (the following formula (III)) of [ln(a_{T})] and [1/(T+273.16)] is calculated by the least-square method from the respective temperatures and the shift factor at each temperature. Subsequently, Ea is obtained from the gradient m of the linear expression and the following formula (IV).

ln(a_{T})=m(1/(T+273.16))+n (III)

Ea=|0.008314×m| (IV)

a_{T}: shift factor

Ea: activation energy of flow (unit: kJ/mol)

T: temperature (unit: ° C.)

The calculation may use commercially available calculation software, and examples of the calculation software include Rhios V.4.4.4 produced by Rheometrics.

The shift factor is a shift amount when both logarithmic curves of melting complex viscosity-angular frequency at the respective temperatures are shifted to the direction of log(Y)=−log(X) axis, provided that Y-axis indicates melting complex viscosity and X-axis indicates angular frequency, and are superposed on a melting complex viscosity-angular frequency curve at 190° C. In the superposition, both logarithmic curves of melting complex viscosity-angular frequency at the respective temperatures are shifted to aT times in angular frequency and to 1/a_{T} times in melting complex viscosity, with regard to every curve. The correlation coefficient in calculating the formula (I) by the least-square method from the values at four points of 130° C., 150° C., 170° C., and 190° C., is generally not less than 0.99.

The measurement of the melt complex viscosity-angular frequency curve is performed using a viscoelasticity measuring apparatus (e.g., Rheometrics Mechanical Spectrometer RMS-800 manufactured by Rheometrics), usually, under the conditions of geometry: parallel plates, a plate diameter: 25 mm, a plate interval: 1.5 to 2 mm, a strain: 5%, and an angular frequency: 0.1 to 100 rad/sec. The measurement is performed under the nitrogen atmosphere, and it is preferable to blend an appropriate amount (e.g., 1000 ppm) of an antioxidant into a measurement sample in advance.

It is preferable for the ethylene-α-olefin copolymer of the present invention that an elution curve measured by the temperature rising elution fractionation method has two elution peaks, the elution peak of the higher temperature side is within the range of 82° C. to 100° C., and the elution peak of the lower temperature side is present within the range of 70° C. to 82° C. It is preferable for the ethylene-α-olefin copolymer of the present invention that the height of the elution peak of the higher temperature side (H) is greater as compared with the height of the elution peak of the lower temperature side (L) and the ratio of H to L (H/L) is from 1.0 to 5.0. H/L indicates the width of composition distribution; if H/L is smaller than 1.0, then eluted components will increase at low temperatures and accordingly, for example, component migration from the surface of a container formed using an ethylene-α-olefin copolymer to contents may occur, whereas if H/L is larger than 5.0, then the strength of an article may decrease. More preferably, H/L is from 1.5 to 4.0.

The ethylene-α-olefin copolymer of the present invention is characterized by the weight average molecular weights of the components eluted at the elution temperatures corresponding to two elution peaks observed with the elution curve measured by temperature rising elution fractionation, and it is preferable that the weight average molecular weight of the component eluted at the temperature of the elution peak of the higher temperature side Mw (H) is within the range of 35,000 to 110,000 and the weight average molecular weight of the component eluted at the temperature of the elution peak of the lower temperature side Mw(L) is within the range of 65,000 to 80,000. When the molecular weight of the lower temperature eluted component is greater than the molecular weight of the higher temperature eluted component, superior mechanical strength is achieved. However, if the weight average molecular weight of the component eluted at the temperature of the elution peak of the higher temperature side is excessively low or the weight molecular weight of the component eluted at the temperature of the elution peak of the lower temperature side is excessively high, mechanical strength may deteriorate. It is preferable for the ethylene-α-olefin copolymer of the present invention that Mw(L)/Mw(H), which is the ratio of Mw(L) to Mw(H), is from 1.3 to 4.0. If Mw(L)/Mw(H) is excessively large, mechanical strength will deteriorate, and if Mw(L)/Mw(H) is excessively small, processability will deteriorate.

It is preferable for the ethylene-α-olefin copolymer of the present invention that the amount of the components eluted at temperatures equal to or higher than 96° C. is not more than 0.5% and the amount of the components eluted at temperatures equal to or lower than 60° C. is not more than 12% in the elution curve measured by temperature rising elution fractionation. The components eluted at temperatures equal to or higher than 96° C. indicate the presence of ethylene-α-olefin copolymer components with a few branches. The presence of ethylene-α-olefin copolymer components with a few branches leads to decrease in mechanical strength. The components eluted at temperatures equal to or lower than 60° C. indicate the presence of ethylene-α-olefin copolymer components with many branches. Since the presence of a large amount of ethylene-α-olefin copolymer components having many branches may cause component transition from the surface of a container molded from the copolymer to contents, the amount of the components is preferably little. The amount of the components eluted at temperatures equal to or lower than 60° C. is more preferably not more than 10%.

Measurement by temperature rising elution fractionation is conducted under the following conditions using the instrument provided below.

Instrument: CFC T150A, manufactured by Mitsubishi Chemical Corporation

Detector: Magna-TR550, manufactured by Nicolet-Japan Corp.

Wavelength: data range 2982 to 2842 cm⁻¹

Column: UT-806M produced by Showa Denko K.K., 2 columns

Solvent: o-dichlorobenzene

Flow rate: 60 ml/hour

Sample concentration: 100 mg/25 ml

Sample injection: 0.8 ml

Loading conditions: Temperature is lowered from 140° C. to 0° C. at a rate of 1° C./min, followed by being left at rest for 30 minutes, and then elution is initiated from 0° C. fraction.

The ethylene-α-olefin copolymer of the present invention is produced by copolymerizing ethylene and an α-olefin using a catalyst formed by bringing a transition metal compound (A1) represented by the following formula (1), a transition metal compound (A2) represented by the following formula (2), the below-described component (B), and the below-described component (C) into contact with each other. The molar ratio of the transition metal compound (A1) to the transition metal compound (A2) ((A1)/(A2)) is preferably from 0.3 to 30. From the viewpoint of reducing the relaxation time of the molecular chain of the ethylene-α-olefin copolymer in a molten state and increasing mechanical strength, (A1)/(A2) is preferably not less than 1, and more preferably not less than 3. From the viewpoint of increasing SR, (A1)/(A2) is preferably not more than 30 and more preferably not more than 15.

The combined usage amount of the transition metal compound (A1) and the transition metal compound (A2) for 1 g of component (B) is preferably 1×10⁻⁶ to 1×10⁻³ mol, and more preferably 5×10⁻⁶ to 1×10⁻⁴ mol.

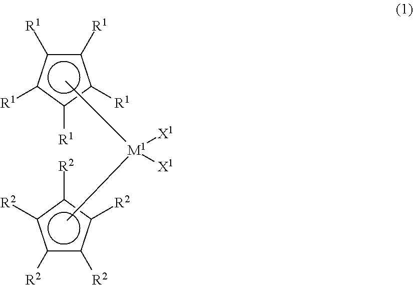

wherein M¹ represents a transition metal atom of Group 4 of the periodic table of the elements, and X¹, R¹, and R² are each independently a hydrogen atom, a halogen atom, an optionally substituted hydrocarbyl group having 1 to 20 carbon atoms, an optionally substituted hydrocarbyloxy group having 1 to 20 carbon atoms, a substituted silyl group having 1 to 20 carbon atoms, or a substituted amino group having 1 to 20 carbon atoms, wherein the X¹ groups maybe the same or different, the R¹ groups maybe the same or different, and the R² groups may be the same or different.

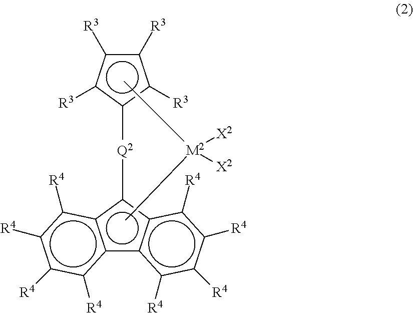

wherein M² represents a transition metal atom of Group 4 of the periodic table of the elements, and X², R³, and R⁴ are each independently a hydrogen atom, a halogen atom, an optionally substituted hydrocarbyl group having 1 to 20 carbon atoms, an optionally substituted hydrocarbyloxy group having 1 to 20 carbon atoms, a substituted silyl group having 1 to 20 carbon atoms, or a substituted amino group having 1 to 20 carbon atoms, wherein the X² groups may be the same or different, the R³ groups may be the same or different, the R⁴ groups may be the same or different, and Q² represents a bridging group represented by the following formula (3),

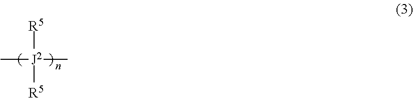

wherein n is an integer of from 1 to 5; J² represents an atom of Group 14 of the periodic table of the elements; R⁵ is a hydrogen atom, a halogen atom, an optionally substituted hydrocarbyl group having 1 to 20 carbon atoms, an optionally substituted hydrocarbyloxy group having 1 to 20 carbon atoms, a substituted silyl group having 1 to 20 carbon atoms, or a substituted amino group having 1 to 20 carbon atoms; and the R⁵ groups may be the same or different.
Component (B): the following component (B-1) and/or the following component (B-2).
Component (B-1): a solid catalyst component that is formed by bringing the following component (a) and the following component (b) into contact with each other.

Component (a): at least one compound selected from the group consisting of (a-1) organometallic compounds of metals of Group 13 of the periodic table of the elements, (a-2) organoaluminumoxy compound, and (a-3) boron compounds.

Component (b): a solid state carrier.

Component (B-2): a modified clay mineral that is formed by bringing an organic compound and a clay mineral into contact with each other.
Component (C): an organoaluminum compound.

M¹ of formula (1) and M² of formula (2) represent a transition metal atom of Group 4 of the periodic table of the elements, examples of which include a titanium atom, a zirconium atom, and a hafnium atom.

X¹, R¹, and R² of formula (1) and X², and R⁴ of formula (2) are each independently a hydrogen atom, a halogen atom, an optionally substituted hydrocarbyl group having 1 to 20 carbon atoms, an optionally substituted hydrocarbyloxy group having 1 to 20 carbon atoms, a substituted silyl group having 1 to 20 carbon atoms, or a substituted amino group having 1 to 20 carbon atoms, wherein the plurality of X¹s may be the same or different, the R¹ groups may be the same or different, the R² groups may be the same or different, the X² groups may be the same or different, the R³ groups may be the same or different, and the R⁴ groups may be the same or different.

Examples of the halogen atoms of X¹, R¹, R², X², R³, and R⁴ include a fluorine atom, a chlorine atom, a bromine atom, and an iodine atom.

Examples of the optionally substituted hydrocarbyl groups having 1 to 20 carbon atoms of X¹, R¹, R², X², R³, and R⁴ include alkyl groups having 1 to 20 carbon atoms, halogenated alkyl groups having 1 to 20 carbon atoms, aralkyl groups having 7 to 20 carbon atoms, and aryl groups having 6 to 20 carbon atoms.

Examples of said alkyl groups having 1 to 20 carbon atoms include a methyl group, an ethyl group, a n-propyl group, an isopropyl group, a n-butyl group, a sec-butyl group, a tert-butyl group, a n-pentyl group, a neopentyl group, an isopentyl group, a n-hexyl group, a n-heptyl group, a n-octyl group, a n-decyl group, a n-nonyl group, a n-decyl group, a n-dodecyl group, a n-dodecyl group, a n-tridecyl group, a n-tetradecyl group, a n-pentadecyl group, a n-hexadecyl group, a n-heptadecyl group, a n-octadecyl group, a n-nonadecyl group, and a n-eicosyl group.

Examples of said halogenated alkyl groups having 1 to 20 carbon atoms include a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, and a perbromoeicosyl group.

Examples of said aralkyl groups having 7 to 20 carbon atoms include a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-decylphenyl)methyl group, a (n-tetradecylphenyl)methyl group, a naphthylmethyl group, an anthracenylmethyl group, a phenylethyl group, a phenylpropyl group, a phenylbutyl group, a diphenylmethyl group, a diphenylethyl group, a diphenylpropyl group, and a diphenylbutyl group. Additional examples include halogenated aralkyl groups in which these aralkyl groups are substituted with a halogen atom such as a fluorine atom, a chlorine atom, a bromine atom, or an iodine atom.

Examples of said aryl groups having 6 to 20 carbon atoms include a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a diethylphenyl group, a triethylphenyl group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group, and an anthracenyl group. Additional examples include halogenated aryl groups in which these aryl groups are substituted with a halogen atom such as a fluorine atom, a chlorine atom, a bromine atom, or an iodine atom.

Examples of said optionally substituted hydrocarbyl groups having 1 to 20 carbon atoms include hydrocarbyl groups substituted with a substituted silyl group, hydrocarbyl groups substituted with a substituted amino group, and hydrocarbyl groups substituted with a hydrocarbyloxy group.

Examples of said hydrocarbyl groups substituted with a substituted silyl group include a trimethylsilylmethyl group, a trimethylsilylethyl group, a trimethylsilylpropyl group, a trimethylsilylbutyl group, a trimethylsilylphenyl group, a bis(trimethylsilyl)methyl group, a bis(trimethylsilyl)ethyl group, a bis(trimethylsilyl)propyl group, a bis(trimethylsilyl)butyl group, a bis(trimethylsilyl)phenyl group, and a triphenylsilylmethyl group.

Examples of said hydrocarbyl groups substituted with a substituted amino group include a dimethylaminomethyl group, a dimethylaminoethyl group, a dimethylaminopropyl group, a dimethylaminobutyl group, a dimethylaminophenyl group, a bis(dimethylamino)methyl group, a bis(dimethylamino)ethyl group, a bis(dimethylamino)propyl group, a bis(dimethylamino)butyl group, a bis(dimethylamino)phenyl group, a phenylaminomethyl group, a diphenylaminomethyl group, and a diphenylaminophenyl group.

Examples of said hydrocarbyl groups substituted with a hydrocarbyloxy group include a methoxymethyl group, an ethoxymethyl group, a n-propoxymethyl group, an isopropoxymethyl group, n-butoxymethyl group, a sec-butoxymethyl group, a tert-butoxymethyl group, a phenoxymethyl group, a methoxyethyl group, an ethoxyethyl group, a n-propoxyethyl group, an isopropoxyethyl group, a n-butoxyethyl group, a sec-butoxyethyl group, a tert-butoxyethyl group, a phenoxyethyl group, a methoxy-n-propyl group, an ethoxy-n-propyl group, a n-propoxy-n-propyl group, an isopropoxy-n-propyl group, a n-butoxy-n-propyl group, a sec-butoxy-n-propyl group, a tert-butoxy-n-propyl group, a phenoxy-n-propyl group, a methoxyisopropyl group, an ethoxyisopropyl group, a n-propoxyisopropyl group, an isopropoxyisopropyl group, a n-butoxyisopropyl group, a sec-butoxyisopropyl group, a tert-butoxyisopropyl group, a phenoxyisopropyl group, a methoxyphenyl group, an ethoxyphenyl group, a n-propoxyphenyl group, an isopropoxyphenyl group, a n-butoxyphenyl group, a sec-butoxyphenyl group, a tert-butoxyphenyl group, and a phenoxyphenyl group.

Examples of the optionally substituted hydrocarbyloxy groups having 1 to 20 carbon atoms of X¹, R¹, R², X², R³, and R⁴ include alkoxy groups having 1 to 20 carbon atoms, aralkyloxy groups having 7 to 20 carbon atoms, and aryloxy groups having 6 to 20 carbon atoms.

Examples of said alkoxy groups having 1 to 20 carbon atoms include a methoxy group, an ethoxy group, a n-propoxy group, an isopropoxy group, a n-butoxy group, a sec-butoxy group, a tert-butoxy group, a n-pentyloxy group, a neopentyloxy group, a n-hexyloxy group, a n-octyloxy group, a n-nonyloxy group, a n-decyloxy group, a n-undecyloxy group, a n-dodecyloxy group, a n-tridecyloxy group, a n-tetradecyloxy group, a n-pentadecyloxy group, a n-hexadecyloxy group, a n-heptadecyloxy group, a n-heptadecyloxy group, a n-octadecyloxy group, a n-nonadecyloxy group, and a n-eicosoxy group. Additional examples include halogenated alkoxy groups in which these alkoxy groups are substituted with a halogen atom such as a fluorine atom, a chlorine atom, a bromine atom, or an iodine atom.

Examples of said aralkyloxy groups having 7 to 20 carbon atoms include a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, a (n-butylphenyl)methoxy group, a (sec-butylphenyl)methoxy group, a (tert-butylphenyl)methoxy group, a (n-hexylphenyl)methoxy group, a (n-octylphenyl)methoxy group, a (n-decylphenyl)methoxy group, a (n-tetradecylphenyl)methoxy group, a naphthylmethoxy group, and an anthracenylmethoxy group. Additional examples include halogenated aralkyloxy groups in which these aralkyloxy groups are substituted with a halogen atom such as a fluorine atom, a chlorine atom, a bromine atom, or an iodine atom.

Examples of said aryloxy groups having 6 to 20 carbon atoms include a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, a 2,3,5,6-tetramethylphenoxy group, a pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, a n-tetradecylphenoxy group, a naphthoxy group, and an anthracenoxy group. Additional examples include halogenated aryloxy groups in which these aryloxy groups are substituted with a halogen atom such as a fluorine atom, a chlorine atom, a bromine atom, or an iodine atom.

Examples of the substituted silyl groups having 1 to 20 carbon atoms of X¹, R¹, R², X², R³, and R⁴ include silyl groups substituted with hydrocarbyl groups such as an alkyl group and an aryl group. Specific examples include mono-substituted silyl groups such as a methylsilyl group, an ethylsilyl group, a n-propylsilyl group, an isopropyl silyl group, a n-butylsilyl group, a sec-butylsilyl group, a tert-butylsilyl group, an isobutylsilyl group, a n-pentylsilyl group, a n-hexylsilyl group, a phenylsilyl group; di-substituted silyl groups such as a dimethylsilyl group, a diethylsilyl group, a di-n-propylsilyl group, a diisopropylsilyl group, a di-n-butylsilyl group, a di-sec-butylsilyl group, a di-tert-butylsilyl group, a diisobutylsilyl group, and a diphenylsilyl group; tri-substituted silyl groups such as a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a triisobutylsilyl group, a tert-butyl-dimethylsilyl group, a tri-n-pentylsilyl group, a tri-n-hexylsilyl group, a tricyclohexylsilyl group, and a triphenylsilyl group.

Examples of the substituted amino groups having 1 to 20 carbon atoms of X¹, R¹, R², R², R³, and R⁴ include amino groups substituted with two hydrocarbyl groups such as alkyl groups and aryl groups. Specific examples include a methylamino group, an ethylamino group, a n-propylamino group, an isopropylamino group, a n-butylamino group, a sec-butylamino group, a tert-butylamino group, an isobutylamino group, a n-hexylamino group, a n-octylamino group, a n-decylamino group, a phenylamino group, a benzylamino group, a dimethylamino group, a diethylamino group, a di-n-propylamino group, a diisopropylamino group, a di-n-butylamino group, a di-sec-butylamino group, a di-tert-butylamino group, a di-isobutylamino group, a tert-butylisopropylamino group, a di-n-hexylamino group, a di-n-octylamino group, a di-n-decylamino group, a diphenylamino group, a dibenzylamino group, a tert-butylisopropylamino group, a phenyl ethylamino group, a phenylpropylamino group, a phenylbutylamino group, a pyrrolyl group, a pyrrolidinyl group, a piperidinyl group, a carbazolyl group, and a dihydroisoindolyl group.

Preferred as X¹ are a chlorine atom, a methyl group, an ethyl group, a n-propyl group, an isopropyl group, a n-butyl group, a methoxy group, an ethoxy group, a n-propoxy group, an isopropoxy group, a n-butoxy group, a trifluoromethoxy group, a phenyl group, a phenoxy group, a 2,6-di-tert-butylphenoxy group, a 3,4,5-trifluorophenoxy group, a pentafluorophenoxy group, a 2,3,5,6-tetrafluoro-4-pentafluorophenylphenoxy group, and a benzyl group.

Preferred as R¹ are a hydrogen atom and alkyl groups having 1 to 6 carbon atoms, more preferred are a hydrogen atom and alkyl groups having 1 to 4 carbon atoms, and even more preferred is a hydrogen atom.

Preferred as R² are a hydrogen atom and alkyl groups having 1 to 6 carbon atoms, more preferred are a hydrogen atom and alkyl groups having 1 to 4 carbon atoms, and even more preferred is a hydrogen atom.

The structure of a cyclopentadienyl group having five R¹ groups is preferably a structure in which all of the five R¹ groups are hydrogen atoms or a structure in which one or two of the five R¹ groups are alkyl groups having 1 to 6 carbon atoms, and more preferably a structure in which one or more R¹ groups are alkyl groups having 1 to 4 carbon atoms and the rest of the R¹ groups other than the alkyl groups are all hydrogen atoms.

The structure of a cyclopentadienyl group having five R² groups is preferably a structure in which all of the five R² groups are hydrogen atoms or a structure in which one or two of the five R² groups are alkyl groups having 1 to 6 carbon atoms, and more preferably a structure in which one or more R² groups are alkyl groups having 1 to 4 carbon atoms and the rest of the R² groups other than the alkyl groups are all hydrogen atoms.

Preferred as X² are a chlorine atom, a methyl group, an ethyl group, a n-propyl group, an isopropyl group, a n-butyl group, a methoxy group, an ethoxy group, a n-propoxy group, an isopropoxy group, a n-butoxy group, a trifluoromethoxy group, a phenyl group, a phenoxy group, a 2,6-di-tert-butylphenoxy group, a 3,4,5-trifluorophenoxy group, a pentafluorophenoxy group, a 2,3,5,6-tetrafluoro-4-pentafluorophenylphenoxy group, and a benzyl group.

Preferred as R³ are a hydrogen atom and alkyl groups having 1 to 6 carbon atoms, more preferred are a hydrogen atom and alkyl groups having 1 to 4 carbon atoms, and even more preferred is a hydrogen atom.

Preferred as R⁴ are a hydrogen atom and alkyl groups having 1 to 6 carbon atoms, more preferred are a hydrogen atom and alkyl groups having 1 to 4 carbon atoms, and even more preferred is a hydrogen atom.

Q² of formula (2) represents a bridging group represented by formula (3).

n in formula (3) is an integer of 1 to 5. n is preferably 1 to 2. J² in formula (3) represents a transition metal atom of Group 14 of the periodic table of the elements, and examples thereof include a carbon atom, a silicon atom, and a germanium atom. Preferred is a carbon atom or a silicon atom.

The R⁵ groups in formula (3) are each independently a hydrogen atom, a halogen atom, an optionally substituted hydrocarbyl group having 1 to 20 carbon atoms, an optionally substituted hydrocarbyloxy group having 1 to 20 carbon atoms, a substituted silyl group having 1 to 20 carbon atoms, or a substituted amino group having 1 to 20 carbon atoms, wherein the R⁵ groups may be the same or different.

Examples of the halogen atom, the optionally substituted hydrocarbyl group having 1 to 20 carbon atoms, the optionally substituted hydrocarbyloxy group having 1 to 20 carbon atoms, the substituted silyl group having 1 to 20 carbon atoms, and the substituted amino group having 1 to 20 carbon atoms mentioned for R⁵ may be ones provided as examples of the halogen atom, the optionally substituted hydrocarbyl group having 1 to 20 carbon atoms, the optionally substituted hydrocarbyloxy group having 1 to 20 carbon atoms, the substituted silyl group having 1 to 20 carbon atoms, and the substituted amino group having 1 to 20 carbon atoms mentioned for X¹, R¹, R², X², R³, and R⁴.

Examples of Q² include a methylene group, an ethylidene group, an ethylene group, a propylidene group, a propylene group, a butylidene group, a butylene group, a pentylidene group, a pentylene group, a hexylidene group, an isopropylidene group, a methylethylmethylene group, a methylpropylmethylene group, a methylbutylmethylene group, a bis(cyclohexyl)methylene group, a methylphenyl methylene group, a diphenylmethylene group, a phenyl(methylphenyl)methylene group, a di(methylphenyl)methylene group, a bis(dimethylphenyl)methylene group, a bis(trimethylphenyl)methylene group, a phenyl(ethylphenyl)methylene group, a di(ethylphenyl)methylene group, a bis(diethylphenyl)methylene group, a phenyl(propylphenyl)methylene group, a di(propylphenyl)methylene group, a bis(dipropylphenyl)methylene group, a phenyl(butylphenyl)methylene group, a di(butylphenyl)methylene group, a phenyl(naphthyl)methylene group, a di(naphthyl)methylene group, a phenyl(biphenyl)methylene group, a di(biphenyl)methylene group, a phenyl(trimethylsilylphenyl)methylene group, a bis(trimethylsilylphenyl)methylene group, a bis(pentafluorophenyl)methylene group,

a silanediyl group, a disilanediyl group, a trisilanediyl group, a tetrasilanediyl group, a dimethylsilanediyl group, a bis(dimethylsilane)diyl group, a diethylsilanediyl group, a dipropylsilanediyl group, a dibutylsilanediyl group, a diphenylsilanediyl group, a silacyclobutanediyl group, a silacyclohexanediyl group, a divinylsilanediyl group, a diallylsilanediyl group, a (methyl)(vinyl)silanediyl group, and an (allyl)(methyl)silanediyl group.

Q² is preferably a methylene group, an ethylene group, an isopropylidene group, a bis(cyclohexyl)methylene group, a diphenylmethylene group, a dimethylsilane diyl group, or a bis(dimethylsilane)diyl group, and is more preferably a diphenylmethylene group.

Examples of the transition metal compound (A1) represented by formula (1) in which M¹ is a zirconium atom and X¹ is a chlorine atom include bis(cyclopentadienyl)zirconium dichloride, bis(methylcyclopentadienyl)zirconium dichloride, bis(butylcyclopentadienyl)zirconium dichloride, bis(pentamethylcyclopentadienyl)zirconium dichloride,

bis(methylethylcyclopentadienyl)zirconium dichloride, bis(methylpropylcyclopentadienyl)zirconium dichloride, bis(methylbutylcyclopentadienyl)zirconium dichloride, bis(ethylbutylcyclopentadienyl)zirconium dichloride, bis(benzylmethylcyclopentadienyl)zirconium dichloride, bis(methylhexylcyclopentadienyl)zirconium dichloride, bis(methylcyclohexylcyclopentadienyl)zirconium dichloride, and bis(ethylhexylcyclopentadienyl)zirconium dichloride.

The substituted bodies of a cyclopentadienyl group in the examples provided above include all combinations of substituents, and the substituted bodies with substitution at a 1-position and a 3-position or the substituted bodies with substitution at a 1-position and a 2-position are preferred as disubstituted bodies. Further examples include compounds resulting from changing the dichloride of X′ of the above-described transition metal compounds to difluoride, dibromide, diiodide, dimethyl, diethyl, diisopropyl, dimethoxide, diethoxide, dipropoxide, dibutoxide, bis(trifluoromethoxide), diphenyl, diphenoxide, bis(2,6-di-tert-butylphenoxide), bis(3,4,5-trifluorophenoxide), bis(pentafluorophenoxide), bis(2,3,5,6-tetrafluoro-4-pentafluorophenylphenoxide), dibenzyl, etc. Further examples include compounds resulting from changing the zirconium atom of M¹ of the above-disclosed transition metal compounds to a titanium atom or a hafnium atom.

Preferred as the transition metal compound (A1) represented by formula (1) are
bis(butylcyclopentadienyl)zirconium dichloride and
bis(pentamethylcyclopentadienyl)zirconium dichloride.

Examples of the transition metal compound (A2) represented by the formula (2), in which M² is a zirconium atom, X² is a chlorine atom, and the bridging group Q² is a diphenylmethylene group, include
diphenylmethylene(1-cyclopentadienyl)(9-fluorenyl)zirconium dichloride,
diphenylmethylene(2-methyl-1-cyclopentadienyl)(9-fluorenyl)zirconium dichloride,
diphenylmethylene(3-methyl-1-cyclopentadienyl)(9-fluorenyl)zirconium dichloride,
diphenylmethylene(2,4-dimethyl-1-cyclopentadienyl)(9-fluorenyl)zirconium dichloride,
diphenylmethylene(2,5-dimethyl-1-cyclopentadienyl)(9-fluorenyl)zirconium dichloride,
diphenylmethylene(3,4-dimethyl-1-cyclopentadienyl)(9-fluorenyl)zirconium dichloride,
diphenylmethylene(2,3,4-trimethyl-1-cyclopentadienyl)(9-fluorenyl)zirconium dichloride,
diphenylmethylene(2,3,5-trimethyl-1-cyclopentadienyl)(9-fluorenyl)zirconium dichloride,
diphenylmethylene(3,4,5-trimethyl-1-cyclopentadienyl)(9-fluorenyl)zirconium dichloride,
diphenylmethylene(2,3,4,5-tetramethyl-1-cyclopentadienyl)(9-fluorenyl)zirconium dichloride,
diphenylmethylene(2-ethyl-1-cyclopentadienyl)(9-fluorenyl)zirconium dichloride,
diphenylmethylene(3-ethyl-1-cyclopentadienyl)(9-fluorenyl)zirconium dichloride,
diphenylmethylene(2,4-diethyl-1-cyclopentadienyl)(9-fluorenyl)zirconium dichloride,
diphenylmethylene(2,5-diethyl-1-cyclopentadienyl)(9-fluorenyl)zirconium dichloride,
diphenylmethylene(3,4-diethyl-1-cyclopentadienyl)(9-fluorenyl)zirconium dichloride,
diphenylmethylene(2,3,4-triethyl-1-cyclopentadienyl)(9-fluorenyl)zirconium dichloride,
diphenylmethylene(2,3,5-triethyl-1-cyclopentadienyl)(9-fluorenyl)zirconium dichloride,
diphenylmethylene(3,4,5-triethyl-1-cyclopentadienyl)(9-fluorenyl)zirconium dichloride,
diphenylmethylene(2,3,4,5-tetraethyl-1-cyclopentadienyl)(9-fluorenyl)zirconium dichloride,
diphenylmethylene(2-n-propyl-1-cyclopentadienyl)(9-fluorenyl)zirconium dichloride,
diphenylmethylene(3-n-propyl-1-cyclopentadienyl)(9-fluorenyl)zirconium dichloride,
diphenylmethylene(2,4-di-n-propyl-1-cyclopentadienyl)(9-fluorenyl)zirconium dichloride,
diphenylmethylene(2,5-di-n-propyl-1-cyclopentadienyl)(9-fluorenyl)zirconium dichloride,
diphenylmethylene(3,4-di-n-propyl-1-cyclopentadienyl)(9-fluorenyl)zirconium dichloride,
diphenylmethylene(2,3,4-tri-n-propyl-1-cyclopentadienyl)(9-fluorenyl)zirconium dichloride,
diphenylmethylene(2,3,5-tri-n-propyl-1-cyclopentadienyl)(9-fluorenyl)zirconium dichloride,
diphenylmethylene(3,4,5-tri-n-propyl-1-cyclopentadienyl)(9-fluorenyl)zirconium dichloride,
diphenylmethylene(2,3,4,5-tetra-n-propyl-1-cyclopentadienyl)(9-fluorenyl)zirconium dichloride,
diphenylmethylene(2-isopropyl-1-cyclopentadienyl)(9-fluorenyl)zirconium dichloride,
diphenylmethylene(3-isopropyl-1-cyclopentadienyl)(9-fluorenyl)zirconium dichloride,
diphenylmethylene(2,4-diisopropyl-1-cyclopentadienyl)(9-fluorenyl)zirconium dichloride,
diphenylmethylene(2,5-diisopropyl-1-cyclopentadienyl)(9-fluorenyl)zirconium dichloride,
diphenylmethylene(3,4-diisopropyl-1-cyclopentadienyl)(9-fluorenyl)zirconium dichloride,
diphenylmethylene(2,3,4-triisopropyl-1-cyclopentadienyl)(9-fluorenyl)zirconium dichloride,
diphenylmethylene(2,3,5-triisopropyl-1-cyclopentadienyl)(9-fluorenyl)zirconium dichloride,
diphenylmethylene(3,4,5-triisopropyl-1-cyclopentadienyl)(9-fluorenyl)zirconium dichloride,
diphenylmethylene(2,3,4,5-tetraisopropyl-1-cyclopentadienyl)(9-fluorenyl)zirconium dichloride,
diphenylmethylene(2-phenyl-1-cyclopentadienyl)(9-fluorenyl)zirconium dichloride,
diphenylmethylene(3-phenyl-1-cyclopentadienyl)(9-fluorenyl)zirconium dichloride,
diphenylmethylene(2,4-diphenyl-1-cyclopentadienyl)(9-fluorenyl)zirconium dichloride,
diphenylmethylene(2,5-diphenyl-1-cyclopentadienyl)(9-fluorenyl)zirconium dichloride,
diphenylmethylene(3,4-diphenyl-1-cyclopentadienyl)(9-fluorenyl)zirconium dichloride,
diphenylmethylene(2,3,4-triphenyl-1-cyclopentadienyl)(9-fluorenyl)zirconium dichloride,
diphenylmethylene(2,3,5-triphenyl-1-cyclopentadienyl)(9-fluorenyl)zirconium dichloride,
diphenylmethylene(3,4,5-triphenyl-1-cyclopentadienyl)(9-fluorenyl)zirconium dichloride,
diphenylmethylene(2,3,4,5-tetraphenyl-1-cyclopentadienyl)(9-fluorenyl)zirconium dichloride,
diphenylmethylene(2-trimethylsilyl-1-cyclopentadienyl)(9-fluorenyl)zirconium dichloride,
diphenylmethylene(3-trimethylsilyl-1-cyclopentadienyl)(9-fluorenyl)zirconium dichloride,
diphenylmethylene(2,4-bis(trimethylsilyl)-1-cyclopentadienyl)(9-fluorenyl)zirconium dichloride,
diphenylmethylene(2,5-bis(trimethylsilyl)-1-cyclopentadienyl)(9-fluorenyl)zirconium dichloride,
diphenylmethylene(3,4-bis(trimethylsilyl)-1-cyclopentadienyl)(9-fluorenyl)zirconium dichloride,
diphenylmethylene(2,3,4-tris(trimethylsilyl)-1-cyclopentadienyl)(9-fluorenyl)zirconium dichloride,
diphenylmethylene(2,3,5-tris(trimethylsilyl)-1-cyclopentadienyl)(9-fluorenyl)zirconium dichloride,
diphenylmethylene(3,4,5-tris(trimethylsilyl)-1-cyclopentadienyl)(9-fluorenyl)zirconium dichloride,
diphenylmethylene(2,3,4,5-tetrakis(trimethylsilyl)-1-cyclopentadienyl)(9-fluorenyl)zirconium dichloride,
diphenylmethylene(1-cyclopentadienyl)(2,7-dimethyl-9-fluorenyl)zirconium dichloride,
diphenylmethylene(2-methyl-1-cyclopentadienyl)(2,7-dimethyl-9-fluorenyl)zirconium dichloride,
diphenylmethylene(3-methyl-1-cyclopentadienyl)(2,7-dimethyl-9-fluorenyl)zirconium dichloride,
diphenylmethylene(2,4-dimethyl-1-cyclopentadienyl)(2,7-dimethyl-9-fluorenyl)zirconium dichloride,
diphenylmethylene(2,5-dimethyl-1-cyclopentadienyl)(2,7-dimethyl-9-fluorenyl)zirconium dichloride,
diphenylmethylene(3,4-dimethyl-1-cyclopentadienyl)(2,7-dimethyl-9-fluorenyl)zirconium dichloride,
diphenylmethylene(2,3,4-trimethyl-1-cyclopentadienyl)(2,7-dimethyl-9-fluorenyl)zirconium dichloride,
diphenylmethylene(2,3,5-trimethyl-1-cyclopentadienyl)(2,7-dimethyl-9-fluorenyl)zirconium dichloride,
diphenylmethylene(3,4,5-trimethyl-1-cyclopentadienyl)(2,7-dimethyl-9-fluorenyl)zirconium dichloride,
diphenylmethylene(2,3,4,5-tetramethyl-1-cyclopentadienyl)(2,7-dimethyl-9-fluorenyl)zirconium dichloride,
diphenylmethylene(2-ethyl-1-cyclopentadienyl)(2,7-dimethyl-9-fluorenyl)zirconium dichloride,
diphenylmethylene(3-ethyl-1-cyclopentadienyl)(2,7-dimethyl-9-fluorenyl)zirconium dichloride,
diphenylmethylene(2,4-diethyl-1-cyclopentadienyl)(2,7-dimethyl-9-fluorenyl)zirconium dichloride,
diphenylmethylene(2,5-diethyl-1-cyclopentadienyl)(2,7-dimethyl-9-fluorenyl)zirconium dichloride,
diphenylmethylene(3,4-diethyl-1-cyclopentadienyl)(2,7-dimethyl-9-fluorenyl)zirconium dichloride,
diphenylmethylene(2,3,4-triethyl-1-cyclopentadienyl)(2,7-dimethyl-9-fluorenyl)zirconium dichloride,
diphenylmethylene(2,3,5-triethyl-1-cyclopentadienyl)(2,7-dimethyl-9-fluorenyl)zirconium dichloride,
diphenylmethylene(3,4,5-triethyl-1-cyclopentadienyl)(2,7-dimethyl-9-fluorenyl)zirconium dichloride,
diphenylmethylene(2,3,4,5-tetraethyl-1-cyclopentadienyl)(2,7-dimethyl-9-fluorenyl)zirconium dichloride,
diphenylmethylene(2-n-propyl-1-cyclopentadienyl)(2,7-dimethyl-9-fluorenyl)zirconium dichloride,
diphenylmethylene(3-n-propyl-1-cyclopentadienyl)(2,7-dimethyl-9-fluorenyl)zirconium dichloride,
diphenylmethylene(2,4-di-n-propyl-1-cyclopentadienyl)(2,7-dimethyl-9-fluorenyl)zirconium dichloride,
diphenylmethylene(2,5-di-n-propyl-1-cyclopentadienyl)(2,7-dimethyl-9-fluorenyl)zirconium dichloride,
diphenylmethylene(3,4-di-n-propyl-1-cyclopentadienyl)(2,7-dimethyl-9-fluorenyl)zirconium dichloride,
diphenylmethylene(2,3,4-tri-n-propyl-1-cyclopentadienyl)(2,7-dimethyl-9-fluorenyl)zirconium dichloride,
diphenylmethylene(2,3,5-tri-n-propyl-1-cyclopentadienyl)(2,7-dimethyl-9-fluorenyl)zirconium dichloride,
diphenylmethylene(3,4,5-tri-n-propyl-1-cyclopentadienyl)(2,7-dimethyl-9-fluorenyl)zirconium dichloride,
diphenylmethylene(2,3,4,5-tetra-n-propyl-1-cyclopentadienyl)(2,7-dimethyl-9-fluorenyl)zirconium dichloride,
diphenylmethylene(2-isopropyl-1-cyclopentadienyl)(2,7-dimethyl-9-fluorenyl)zirconium dichloride,
diphenylmethylene(3-isopropyl-1-cyclopentadienyl)(2,7-dimethyl-9-fluorenyl)zirconium dichloride,
diphenylmethylene(2,4-diisopropyl-1-cyclopentadienyl)(2,7-dimethyl-9-fluorenyl)zirconium dichloride,
diphenylmethylene(2,5-diisopropyl-1-cyclopentadienyl)(2,7-dimethyl-9-fluorenyl)zirconium dichloride,
diphenylmethylene(3,4-diisopropyl-1-cyclopentadienyl)(2,7-dimethyl-9-fluorenyl)zirconium dichloride,
diphenylmethylene(2,3,4-triisopropyl-1-cyclopentadienyl)(2,7-dimethyl-9-fluorenyl)zirconium dichloride,
diphenylmethylene(2,3,5-triisopropyl-1-cyclopentadienyl)(2,7-dimethyl-9-fluorenyl)zirconium dichloride,
diphenylmethylene(3,4,5-triisopropyl-1-cyclopentadienyl)(2,7-dimethyl-9-fluorenyl)zirconium dichloride,
diphenylmethylene(2,3,4,5-tetraisopropyl-1-cyclopentadienyl)(2,7-dimethyl-9-fluorenyl)zirconium dichloride,
diphenylmethylene(2-phenyl-1-cyclopentadienyl)(2,7-dimethyl-9-fluorenyl)zirconium dichloride,
diphenylmethylene(3-phenyl-1-cyclopentadienyl)(2,7-dimethyl-9-fluorenyl)zirconium dichloride,
diphenylmethylene(2,4-diphenyl-1-cyclopentadienyl)(2,7-dimethyl-9-fluorenyl)zirconium dichloride,
diphenylmethylene(2,5-diphenyl-1-cyclopentadienyl)(2,7-dimethyl-9-fluorenyl)zirconium dichloride,
diphenylmethylene(3,4-diphenyl-1-cyclopentadienyl)(2,7-dimethyl-9-fluorenyl)zirconium dichloride,
diphenylmethylene(2,3,4-triphenyl-1-cyclopentadienyl)(2,7-dimethyl-9-fluorenyl)zirconium dichloride,
diphenylmethylene(2,3,5-triphenyl-1-cyclopentadienyl)(2,7-dimethyl-9-fluorenyl)zirconium dichloride,
diphenylmethylene(3,4,5-triphenyl-1-cyclopentadienyl)(2,7-dimethyl-9-fluorenyl)zirconium dichloride,
diphenylmethylene(2,3,4,5-tetraphenyl-1-cyclopentadienyl)(2,7-dimethyl-9-fluorenyl)zirconium dichloride,
diphenylmethylene(2-trimethylsilyl-1-cyclopentadienyl)(2,7-dimethyl-9-fluorenyl)zirconium dichloride,
diphenylmethylene(3-trimethylsilyl-1-cyclopentadienyl)(2,7-dimethyl-9-fluorenyl)zirconium dichloride,
diphenylmethylene(2,4-bis(trimethylsilyl)-1-cyclopentadienyl)(2,7-dimethyl-9-fluorenyl)zirconium dichloride,
diphenylmethylene(2,5-bis(trimethylsilyl)-1-cyclopentadienyl)(2,7-dimethyl-9-fluorenyl)zirconium dichloride,
diphenylmethylene(3,4-bis(trimethylsilyl)-1-cyclopentadienyl)(2,7-dimethyl-9-fluorenyl)zirconium dichloride,
diphenylmethylene(2,3,4-tris(trimethylsilyl)-1-cyclopentadienyl)(2,7-dimethyl-9-fluorenyl)zirconium dichloride,
diphenylmethylene(2,3,5-tris(trimethylsilyl)-1-cyclopentadienyl)(2,7-dimethyl-9-fluorenyl)zirconium dichloride,
diphenylmethylene(3,4,5-tris(trimethylsilyl)-1-cyclopentadienyl)(2,7-dimethyl-9-fluorenyl)zirconium dichloride,
diphenylmethylene(2,3,4,5-tetrakis(trimethylsilyl)-1-cyclopentadienyl)(2,7-dimethyl-9-fluorenyl)zirconium dichloride,
diphenylmethylene(1-cyclopentadienyl)(2,7-diethyl-9-fluorenyl)zirconium dichloride,
diphenylmethylene(2-methyl-1-cyclopentadienyl)(2,7-diethyl-9-fluorenyl)zirconium dichloride,
diphenylmethylene(3-methyl-1-cyclopentadienyl)(2,7-diethyl-9-fluorenyl)zirconium dichloride,
diphenylmethylene(2,4-dimethyl-1-cyclopentadienyl)(2,7-diethyl-9-fluorenyl)zirconium dichloride,
diphenylmethylene(2,5-dimethyl-1-cyclopentadienyl)(2,7-diethyl-9-fluorenyl)zirconium dichloride,
diphenylmethylene(3,4-dimethyl-1-cyclopentadienyl)(2,7-diethyl-9-fluorenyl)zirconium dichloride,
diphenylmethylene(2,3,4-trimethyl-1-cyclopentadienyl)(2,7-diethyl-9-fluorenyl)zirconium dichloride,
diphenylmethylene(2,3,5-trimethyl-1-cyclopentadienyl)(2,7-diethyl-9-fluorenyl)zirconium dichloride,
diphenylmethylene(3,4,5-trimethyl-1-cyclopentadienyl)(2,7-diethyl-9-fluorenyl)zirconium dichloride,
diphenylmethylene(2,3,4,5-tetramethyl-1-cyclopentadienyl)(2,7-diethyl-9-fluorenyl)zirconium dichloride,
diphenylmethylene(2-ethyl-1-cyclopentadienyl)(2,7-diethyl-9-fluorenyl)zirconium dichloride,
diphenylmethylene(3-ethyl-1-cyclopentadienyl)(2,7-diethyl-9-fluorenyl)zirconium dichloride,
diphenylmethylene(2,4-diethyl-1-cyclopentadienyl)(2,7-diethyl-9-fluorenyl)zirconium dichloride,
diphenylmethylene(2,5-diethyl-1-cyclopentadienyl)(2,7-diethyl-9-fluorenyl)zirconium dichloride,
diphenylmethylene(3,4-diethyl-1-cyclopentadienyl)(2,7-diethyl-9-fluorenyl)zirconium dichloride,
diphenylmethylene(2,3,4-triethyl-1-cyclopentadienyl)(2,7-diethyl-9-fluorenyl)zirconium dichloride,
diphenylmethylene(2,3,5-triethyl-1-cyclopentadienyl)(2,7-diethyl-9-fluorenyl)zirconium dichloride,
diphenylmethylene(3,4,5-triethyl-1-cyclopentadienyl)(2,7-diethyl-9-fluorenyl)zirconium dichloride,
diphenylmethylene(2,3,4,5-tetraethyl-1-cyclopentadienyl)(2,7-diethyl-9-fluorenyl)zirconium dichloride,
diphenylmethylene(2-n-propyl-1-cyclopentadienyl)(2,7-diethyl-9-fluorenyl)zirconium dichloride,
diphenylmethylene(3-n-propyl-1-cyclopentadienyl)(2,7-diethyl-9-fluorenyl)zirconium dichloride,
diphenylmethylene(2,4-di-n-propyl-1-cyclopentadienyl)(2,7-diethyl-9-fluorenyl)zirconium dichloride,
diphenylmethylene(2,5-di-n-propyl-1-cyclopentadienyl)(2,7-diethyl-9-fluorenyl)zirconium dichloride,
diphenylmethylene(3,4-di-n-propyl-1-cyclopentadienyl)(2,7-diethyl-9-fluorenyl)zirconium dichloride,
diphenylmethylene(2,3,4-tri-n-propyl-1-cyclopentadienyl)(2,7-diethyl-9-fluorenyl)zirconium dichloride,
diphenylmethylene(2,3,5-tri-n-propyl-1-cyclopentadienyl)(2,7-diethyl-9-fluorenyl)zirconium dichloride,
diphenylmethylene(3,4,5-tri-n-propyl-1-cyclopentadienyl)(2,7-diethyl-9-fluorenyl)zirconium dichloride,
diphenylmethylene(2,3,4,5-tetra-n-propyl-1-cyclopentadienyl)(2,7-diethyl-9-fluorenyl)zirconium dichloride,
diphenylmethylene(2-isopropyl-1-cyclopentadienyl)(2,7-diethyl-9-fluorenyl)zirconium dichloride,
diphenylmethylene(3-isopropyl-1-cyclopentadienyl)(2,7-diethyl-9-fluorenyl)zirconium dichloride,
diphenylmethylene(2,4-diisopropyl-1-cyclopentadienyl)(2,7-diethyl-9-fluorenyl)zirconium dichloride,
diphenylmethylene(2,5-diisopropyl-1-cyclopentadienyl)(2,7-diethyl-9-fluorenyl)zirconium dichloride,
diphenylmethylene(3,4-diisopropyl-1-cyclopentadienyl)(2,7-diethyl-9-fluorenyl)zirconium dichloride,
diphenylmethylene(2,3,4-triisopropyl-1-cyclopentadienyl)(2,7-diethyl-9-fluorenyl)zirconium dichloride,
diphenylmethylene(2,3,5-triisopropyl-1-cyclopentadienyl)(2,7-diethyl-9-fluorenyl)zirconium dichloride,
diphenylmethylene(3,4,5-triisopropyl-1-cyclopentadienyl)(2,7-diethyl-9-fluorenyl)zirconium dichloride,
diphenylmethylene(2,3,4,5-tetraisopropyl-1-cyclopentadienyl)(2,7-diethyl-9-fluorenyl)zirconium dichloride,
diphenylmethylene(2-phenyl-1-cyclopentadienyl)(2,7-diethyl-9-fluorenyl)zirconium dichloride,
diphenylmethylene(3-phenyl-1-cyclopentadienyl)(2,7-diethyl-9-fluorenyl)zirconium dichloride,
diphenylmethylene(2,4-diphenyl-1-cyclopentadienyl)(2,7-diethyl-9-fluorenyl)zirconium dichloride,
diphenylmethylene(2,5-diphenyl-1-cyclopentadienyl)(2,7-diethyl-9-fluorenyl)zirconium dichloride,
diphenylmethylene(3,4-diphenyl-1-cyclopentadienyl)(2,7-diethyl-9-fluorenyl)zirconium dichloride,
diphenylmethylene(2,3,4-triphenyl-1-cyclopentadienyl)(2,7-diethyl-9-fluorenyl)zirconium dichloride,
diphenylmethylene(2,3,5-triphenyl-1-cyclopentadienyl)(2,7-diethyl-9-fluorenyl)zirconium dichloride,
diphenylmethylene(3,4,5-triphenyl-1-cyclopentadienyl)(2,7-diethyl-9-fluorenyl)zirconium dichloride,
diphenylmethylene(2,3,4,5-tetraphenyl-1-cyclopentadienyl)(2,7-diethyl-9-fluorenyl)zirconium dichloride,
diphenylmethylene(2-trimethylsilyl-1-cyclopentadienyl)(2,7-diethyl-9-fluorenyl)zirconium dichloride,
diphenylmethylene(3-trimethylsilyl-1-cyclopentadienyl)(2,7-diethyl-9-fluorenyl)zirconium dichloride,
diphenylmethylene(2,4-bis(trimethylsilyl)-1-cyclopentadienyl)(2,7-diethyl-9-fluorenyl)zirconium dichloride,
diphenylmethylene(2,5-bis(trimethylsilyl)-1-cyclopentadienyl)(2,7-diethyl-9-fluorenyl)zirconium dichloride,
diphenylmethylene(3,4-bis(trimethylsilyl)-1-cyclopentadienyl)(2,7-diethyl-9-fluorenyl)zirconium dichloride,
diphenylmethylene(2,3,4-tris(trimethylsilyl)-1-cyclopentadienyl)(2,7-diethyl-9-fluorenyl)zirconium dichloride,
diphenylmethylene(2,3,5-tris(trimethylsilyl)-1-cyclopentadienyl)(2,7-diethyl-9-fluorenyl)zirconium dichloride,
diphenylmethylene(3,4,5-tris(trimethylsilyl)-1-cyclopentadienyl)(2,7-diethyl-9-fluorenyl)zirconium dichloride,
diphenylmethylene(2,3,4,5-tetrakis(trimethylsilyl)-1-cyclopentadienyl)(2,7-diethyl-9-fluorenyl)zirconium dichloride,
diphenylmethylene(1-cyclopentadienyl)(2,7-di-tert-butyl-9-fluorenyl)zirconium dichloride,
diphenylmethylene(2-methyl-1-cyclopentadienyl)(2,7-di-tert-butyl-9-fluorenyl)zirconium dichloride,
diphenylmethylene(3-methyl-1-cyclopentadienyl)(2,7-di-tert-butyl-9-fluorenyl)zirconium dichloride,
diphenylmethylene(2,4-dimethyl-1-cyclopentadienyl)(2,7-di-tert-butyl-9-fluorenyl)zirconium dichloride,
diphenylmethylene(2,5-dimethyl-1-cyclopentadienyl)(2,7-di-tert-butyl-9-fluorenyl)zirconium dichloride,
diphenylmethylene(3,4-dimethyl-1-cyclopentadienyl)(2,7-di-tert-butyl-9-fluorenyl)zirconium dichloride,
diphenylmethylene(2,3,4-trimethyl-1-cyclopentadienyl)(2,7-di-tert-butyl-9-fluorenyl)zirconium dichloride,
diphenylmethylene(2,3,5-trimethyl-1-cyclopentadienyl)(2,7-di-tert-butyl-9-fluorenyl)zirconium dichloride,
diphenylmethylene(3,4,5-trimethyl-1-cyclopentadienyl)(2,7-di-tert-butyl-9-fluorenyl)zirconium dichloride,
diphenylmethylene(2,3,4,5-tetramethyl-1-cyclopentadienyl)(2,7-di-tert-butyl-9-fluorenyl)zirconium dichloride,
diphenylmethylene(2-ethyl-1-cyclopentadienyl)(2,7-di-tert-butyl-9-fluorenyl)zirconium dichloride,
diphenylmethylene(3-ethyl-1-cyclopentadienyl)(2,7-di-tert-butyl-9-fluorenyl)zirconium dichloride,
diphenylmethylene(2,4-diethyl-1-cyclopentadienyl)(2,7-di-tert-butyl-9-fluorenyl)zirconium dichloride,
diphenylmethylene(2,5-diethyl-1-cyclopentadienyl)(2,7-di-tert-butyl-9-fluorenyl)zirconium dichloride,
diphenylmethylene(3,4-diethyl-1-cyclopentadienyl)(2,7-di-tert-butyl-9-fluorenyl)zirconium dichloride,
diphenylmethylene(2,3,4-triethyl-1-cyclopentadienyl)(2,7-di-tert-butyl-9-fluorenyl)zirconium dichloride,
diphenylmethylene(2,3,5-triethyl-1-cyclopentadienyl)(2,7-di-tert-butyl-9-fluorenyl)zirconium dichloride,
diphenylmethylene(3,4,5-triethyl-1-cyclopentadienyl)(2,7-di-tert-butyl-9-fluorenyl)zirconium dichloride,
diphenylmethylene(2,3,4,5-tetraethyl-1-cyclopentadienyl)(2,7-di-tert-butyl-9-fluorenyl)zirconium dichloride,
diphenylmethylene(2-n-propyl-1-cyclopentadienyl)(2,7-di-tert-butyl-9-fluorenyl)zirconium dichloride,
diphenylmethylene(3-n-propyl-1-cyclopentadienyl)(2,7-di-tert-butyl-9-fluorenyl)zirconium dichloride,
diphenylmethylene(2,4-di-n-propyl-1-cyclopentadienyl)(2,7-di-tert-butyl-9-fluorenyl)zirconium dichloride,
diphenylmethylene(2,5-di-n-propyl-1-cyclopentadienyl)(2,7-di-tert-butyl-9-fluorenyl)zirconium dichloride,
diphenylmethylene(3,4-di-n-propyl-1-cyclopentadienyl)(2,7-di-tert-butyl-9-fluorenyl)zirconium dichloride,
diphenylmethylene(2,3,4-tri-n-propyl-1-cyclopentadienyl)(2,7-di-tert-butyl-9-fluorenyl)zirconium dichloride,
diphenylmethylene(2,3,5-tri-n-propyl-1-cyclopentadienyl)(2,7-di-tert-butyl-9-fluorenyl)zirconium dichloride,
diphenylmethylene(3,4,5-tri-n-propyl-1-cyclopentadienyl)(2,7-di-tert-butyl-9-fluorenyl)zirconium dichloride,
diphenylmethylene(2,3,4,5-tetra-n-propyl-1-cyclopentadienyl)(2,7-di-tert-butyl-9-fluorenyl)zirconium dichloride,
diphenylmethylene(2-isopropyl-1-cyclopentadienyl)(2,7-di-tert-butyl-9-fluorenyl)zirconium dichloride,
diphenylmethylene(3-isopropyl-1-cyclopentadienyl)(2,7-di-tert-butyl-9-fluorenyl)zirconium dichloride,
diphenylmethylene(2,4-diisopropyl-1-cyclopentadienyl)(2,7-di-tert-butyl-9-fluorenyl)zirconium dichloride,
diphenylmethylene(2,5-diisopropyl-1-cyclopentadienyl)(2,7-di-tert-butyl-9-fluorenyl)zirconium dichloride,
diphenylmethylene(3,4-diisopropyl-1-cyclopentadienyl)(2,7-di-tert-butyl-9-fluorenyl)zirconium dichloride, diphenylmethylene(2,3,4-triisopropyl-1-cyclopentadienyl)(2,7-di-tert-butyl-9-fluorenyl)zirconium dichloride,
diphenylmethylene(2,3,5-triisopropyl-1-cyclopentadienyl)(2,7-di-tert-butyl-9-fluorenyl)zirconium dichloride,
diphenylmethylene(3,4,5-triisopropyl-1-cyclopentadienyl)(2,7-di-tert-butyl-9-fluorenyl)zirconium dichloride,
diphenylmethylene(2,3,4,5-tetraisopropyl-1-cyclopentadienyl)(2,7-di-tert-butyl-9-fluorenyl)zirconium dichloride,
diphenylmethylene(2-phenyl-1-cyclopentadienyl)(2,7-di-tert-butyl-9-fluorenyl)zirconium dichloride,
diphenylmethylene(3-phenyl-1-cyclopentadienyl)(2,7-di-tert-butyl-9-fluorenyl)zirconium dichloride,
diphenylmethylene(2,4-diphenyl-1-cyclopentadienyl)(2,7-di-tert-butyl-9-fluorenyl)zirconium dichloride,
diphenylmethylene(2,5-diphenyl-1-cyclopentadienyl)(2,7-di-tert-butyl-9-fluorenyl)zirconium dichloride,
diphenylmethylene(3,4-diphenyl-1-cyclopentadienyl)(2,7-di-tert-butyl-9-fluorenyl)zirconium dichloride,
diphenylmethylene(2,3,4-triphenyl-1-cyclopentadienyl)(2,7-di-tert-butyl-9-fluorenyl)zirconium dichloride,
diphenylmethylene(2,3,5-triphenyl-1-cyclopentadienyl)(2,7-di-tert-butyl-9-fluorenyl)zirconium dichloride,
diphenylmethylene(3,4,5-triphenyl-1-cyclopentadienyl)(2,7-di-tert-butyl-9-fluorenyl)zirconium dichloride,
diphenylmethylene(2,3,4,5-tetraphenyl-1-cyclopentadienyl)(2,7-di-tert-butyl-9-fluorenyl)zirconium dichloride,
diphenylmethylene(2-trimethylsilyl-1-cyclopentadienyl)(2,7-di-tert-butyl-9-fluorenyl)zirconium dichloride,
diphenylmethylene(3-trimethylsilyl-1-cyclopentadienyl)(2,7-di-tert-butyl-9-fluorenyl)zirconium dichloride,
diphenylmethylene(2,4-bis(trimethylsilyl)-1-cyclopentadienyl)(2,7-di-tert-butyl-9-fluorenyl)zirconium dichloride,
diphenylmethylene(2,5-bis(trimethylsilyl)-1-cyclopentadienyl)(2,7-di-tert-butyl-9-fluorenyl)zirconium dichloride,
diphenylmethylene(3,4-bis(trimethylsilyl)-1-cyclopentadienyl)(2,7-di-tert-butyl-9-fluorenyl)zirconium dichloride,
diphenylmethylene(2,3,4-tris(trimethylsilyl)-1-cyclopentadienyl)(2,7-di-tert-butyl-9-fluorenyl)zirconium dichloride,
diphenylmethylene(2,3,5-tris(trimethylsilyl)-1-cyclopentadienyl)(2,7-di-tert-butyl-9-fluorenyl)zirconium dichloride,
diphenylmethylene(3,4,5-tris(trimethylsilyl)-1-cyclopentadienyl)(2,7-di-tert-butyl-9-fluorenyl)zirconium dichloride,
diphenylmethylene(2,3,4,5-tetrakis(trimethylsilyl)-1-cyclopentadienyl)(2,7-di-tert-butyl-9-fluorenyl)zirconium dichloride.

Further examples include compounds resulting from changing the dichloride of X² of the above-disclosed transition metal compounds to difluoride, dibromide, diiodide, dimethyl, diethyl, diisopropyl, dimethoxide, diethoxide, dipropoxide, dibutoxide, bis(trifluoromethoxide), diphenyl, diphenoxide, bis(2,6-di-tert-butylphenoxide), bis(3,4,5-trifluorophenoxide), bis(pentafluorophenoxide), bis(2,3,5,6-tetrafluoro-4-pentafluorophenyl phenoxide), dibenzyl, etc. Still further examples include compounds resulting from changing the diphenylmethylene group of Q² of the above-disclosed transition metal compounds to a methylene group, an ethylene group, an isopropylidene group, a methylphenylmethylene group, a dimethylsilanediyl group, a diphenylsilanediyl group, a silacyclobutanediyl group, a silacyclohexanediyl group, etc. Further examples include compounds resulting from changing the zirconium atom of M² of the above-disclosed transition metal compounds to a titanium atom or a hafnium atom.

Preferred as the transition metal compound (A2) represented by the formula (2) is diphenylmethylene(1-cyclopentadienyl)(9-fluorenyl)zirconium dichloride.

The component (B) to be used for the preparation of the catalyst for polymerization to be used for the production of the ethylene-α-olefin copolymer of the present invention is the above-mentioned component (B-1) and/or the above-mentioned component (B-2).

The component (B-1) is a solid state catalyst component that is formed by bringing the above-mentioned component (a) and the above-mentioned component (b) into contact with each other.

The organometallic compound of Group 13 of the periodic table of the elements of component (a-1) to be used for component (a) is preferably an organoaluminum compound. Examples of such an organoaluminum compound include trialkyl aluminums, dialkylaluminum chlorides, alkylaluminum dichlorides, dialkylaluminum hydrides, alkyl(dialkoxy)aluminums, dialkyl(alkoxy)aluminums, alkyl(diaryloxy)aluminums, and dialkyl(aryloxy)aluminums.

Examples of such trialkylaluminums include trimethylaluminum, triethylaluminum, tri-n-propylaluminum, tri-n-butylaluminum, triisobutylaluminum, tri-n-hexylaluminum, and tri-n-octylaluminum.

Examples of such dialkylaluminum chlorides include dimethylaluminum chloride, diethylaluminum chloride, di-n-propylaluminum chloride, di-n-butylaluminum chloride, diisobutyl aluminum chloride, and di-n-hexylaluminum chloride.

Examples of such alkylaluminum dichloride include methylaluminum dichloride, ethylaluminum dichloride, n-propylaluminum dichloride, n-butylaluminum dichloride, isobutylaluminum dichloride, and n-hexylaluminum dichloride.

Examples of such dialkylaluminum hydrides include dimethylaluminum hydride, diethylaluminum hydride, di-n-propylaluminum hydride, di-n-butylaluminum hydride, diisobutylaluminum hydride, and di-n-hexylaluminum hydride.

Examples of such alkyl(dialkoxy)aluminums include methyl(dimethoxy)aluminum, methyl(diethoxy)aluminum, and methyl(di-tert-butoxy)aluminum.

Examples of such dialkyl(alkoxy)aluminums include dimethyl(methoxy)aluminum, dimethyl(ethoxy)aluminum, and methyl(tert-butoxy)aluminum.

Examples of such alkyl(diaryloxy)aluminums include methyl(diphenoxy)aluminum, methylbis(2,6-diisopropylphenoxy)aluminum, and methylbis(2,6-diphenylphenoxy)aluminum.

Examples of such dialkyl(aryloxy)aluminums include dimethyl(phenoxy)aluminum, dimethyl(2,6-diisopropylphenoxy)aluminum, and dimethyl(2,6-diphenylphenoxy)aluminum.

As to such organoaluminum compounds, a single species may be used alone or two or more species may be used in combination.

As such organoaluminum compounds, preferred are trialkylaluminums, more preferred is trimethylaluminum, triethylaluminum, tri-n-butylaluminum, triisobutylaluminum, tri-n-hexylaluminum, or tri-n-octylaluminum, and even more preferred is triisobutylaluminum or tri-n-octylaluminum.

Examples of the organoaluminumoxy compound of a component (a-2) to be used for component (a) include cyclic aluminoxanes represented by the following formula [1] and linear aluminoxanes represented by the following formula [2]:

{—Al(R⁶)—O—}ᵢ [1]

wherein R⁶ represents a hydrocarbon group, and the two or more R⁶ groups may be the same or different; and i represents an integer of 2 or more,

R⁷{—Al(R⁷)—O—}ⱼAlR⁷₂ [2]

wherein R⁷ represents a hydrocarbon group, and the two or more R⁷ groups may be the same or different; and j represents an integer of 1 or more.

As the hydrocarbon groups of R⁶ in formula [1] and R⁷ in formula [2], preferred are hydrocarbon groups having 1 to 8 carbon atoms, and more preferred are alkyl groups having 1 to 8 carbon atoms. Examples of such alkyl groups having 1 to 8 carbon atoms include a methyl group, an ethyl group, a n-propyl group, an isopropyl group, a n-butyl group, an isobutyl group, n-pentyl group, and a neopentyl group, and preferred is a methyl group or an isobutyl group.

The i in formula [1] is preferably an integer of 2 to 40, and the j in formula [2] is preferably an integer of 1 to 40.

The cyclic aluminoxanes represented by formula [1] and the linear aluminoxanes represented by formula [2] can be produced by various methods. Such production methods are not particularly restricted and may be conventional production methods. Examples of such production methods include a method in which the production is done by bringing a solution in which a trialkylaluminum such as trimethylaluminum has been dissolved in a proper organic solvent, such as benzene and aliphatic hydrocarbons, into contact with water, and a method in which the production is done by bringing a trialkylaluminum such as trimethylaluminum into contact with a metal salt containing water of crystallization such as copper sulfate hydrate. As to such organoaluminumoxy compounds, a single species may be used alone or two or more species may be used in combination. Preferred are organoaluminumoxy compounds prepared from trimethylaluminum or triisobutylaluminum.

As component (a-3) boron compound to be used for component (a), one or more boron compounds selected from (c-1) boron compounds represented by formula BQ¹Q²Q³, (c-2) boron compounds represented by formula G⁺(BQ⁴Q⁵Q⁶Q⁷)⁻, and (c-3) boron compounds represented by formula (L-H)⁺(BQ⁸Q⁹Q¹⁰Q¹¹)⁻ are used.

In (c-1) the boron compounds represented by formula BQ¹Q²Q³, B is a trivalent boron atom, and Q¹ through Q³ are a halogen atom, a hydrocarbon group, a halogenated hydrocarbon group, a substituted silyl group, an alkoxy group, or a di-substituted amino group and they may be the same or different. Preferably, Q¹ through Q³ are a halogen atom, a hydrocarbon group having 1 to 20 carbon atoms, a halogenated hydrocarbon group having 1 to 20 carbon atoms, a substituted silyl group having 1 to 20 carbon atoms, an alkoxy group having 1 to 20 carbon atoms, or an amino group having 2 to 20 carbon atoms, and Q¹ through Q³ are more preferably a halogen atom, a hydrocarbon group having 1 to 20 carbon atoms, or a halogenated hydrocarbon group having 1 to 20 carbon atoms.

More preferably, Q¹ through Q⁴ are each a fluorinated hydrocarbon group having 1 to 20 carbon atoms and having at least one fluorine atom, and particularly preferably Q¹ through Q⁴ are each a fluorinated aryl group having 6 to 20 carbon atoms and having at least one fluorine atom.

Specific examples of compound (c-1) include tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, and phenylbis(pentafluorophenyl)borane, and most preferred is tris(pentafluorophenyl)borane.

In the boron compound (c-2) represented by formula G⁺(BQ⁴Q⁵Q⁶Q⁷)⁻, G⁺ is an inorganic or organic cation, B is a trivalent boron atom, and Q⁴ through Q⁷ are as defined for Q¹ through Q³ in the aforementioned (c-1).

Specific examples of the inorganic cation G⁺ in the compound represented by formula G⁺(BQ⁴Q⁵Q⁶Q⁷)⁻ include a ferrocenium cation, alkyl-substituted ferrocenium cations, and silver cation, and specific examples of the organic cation G⁺ include a triphenylmethyl cation. Preferred as G⁺ are carbenium cations, and particularly preferred is a triphenylmethyl cation. Examples of (BQ⁴Q⁵Q⁶Q⁷)⁻ include tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,3,4-trifluorophenyl)borate, phenyltris(pentafluorophenyl)borate, and tetrakis(3,5-bis-trifluoromethylphenyl)borate.

Specific combinations thereof include ferrocenium tetrakis(pentafluorophenyl)borate, 1,1′-dimethylferrocenium tetrakis(pentafluorophenyl)borate, silver tetrakis(pentafluorophenyl)borate, tripheylmethyltetrakis(pentafluorophenyl)borate, and triphenylmethyltetrakis(3,5-bistrifluoromethylphenyl)borate; most preferred is triphenylcarbeniumtetrakis(pentafluorophenyl)borate.

In the boron compound (c-3) of formula (L-H)⁺(BQ⁸Q⁹Q¹⁰Q¹¹)⁻, L is a neutral Lewis base and (L-H)⁺ is a Brønsted acid, B is a trivalent boron atom, and Q⁸ through Q¹¹ are as defined for Q¹ through Q³ in the aforementioned Lewis acid (c-1).

Specific examples of the Brønsted acid (L-H)⁺ in the compound represented by formula (L-H)⁺(BQ⁸Q⁹Q¹⁰Q¹¹)⁻ include trialkyl-substituted ammoniums, N,N-dialkylaniliniums, dialkylammoniums, and triarylphosphoniums, and examples of (BQ⁸Q⁹Q¹⁰Q¹¹)⁻ are the same as the examples provided for (BQ⁴Q⁵Q⁶Q⁷)⁻.

Examples of specific combinations thereof include triethylammonium tetrakis(pentafluorophenyl)borate, tripropylammoniumtetrakis(pentafluorophenyl)borate, tri(n-butyl)ammonium tetrakis (pentafluorophenyl)borate, tri(n-butyl)ammonium tetrakis(3,5-bis-trifluoromethylphenyl)borate, N,N-dimethylanilinium tetrakis(pentafluorophenyl)borate, N,N-diethylanilinium tetrakis(pentafluorophenyl)borate, N,N-2,4,6-pentamethylanilinium tetrakis(pentafluorophenyl)borate, N,N-dimethylanilinium tetrakis(3,5-bis-trifluoromethylphenyl)borate, diisopropylammonium tetrakis(pentafluorophenyl)borate, dicyclohexylammonium tetrakis(pentafluorophenyl)borate, triphenylphosphonium tetrakis(pentafluorophenyl)borate, tri(methylphenyl)phosphonium tetrakis(pentafluorophenyl)borate, and tri(dimethylphenyl)phosphonium tetrakis(pentafluorophenyl)borate. Most preferred is tri(n-butyl)ammonium tetrakis(pentafluorophenyl)borate or N,N-dimethylanilinium tetrakis(pentafluorophenyl)borate.

As component (a), preferred is the organoaluminumoxy compound of component (a-2).

The solid state carrier to be used for component (b) is an inorganic or organic compound that is in the form of particulate solid and that is a carrier capable of supporting thereon the components described above.

Examples of the inorganic compounds include porous oxides, inorganic chlorides, clays, clay minerals or ion-exchanging layered compounds; preferably, porous oxides or inorganic chlorides described below can be used.

Specifically, SiO₂, Al₂O₃, MgO, ZrO, TiO₂, B₂O₃, CaO, ZnO, BaO, ThO₂, and the like or composites or mixtures containing these oxides can be used as the porous oxides. There can be used as said composite or said mixture naturally occurring or synthetic zeolite, SiO₂—MgO, SiO₂—Al₂O₃, SiO₂—TiO₂, SiO₂—V₂O₅, SiO₂—Cr₂O₃, SiO₂—TiO₂—MgO, and the like. Out of these, those containing SiO₂ as a major component are preferred.

The inorganic oxides may contain small amounts of carbonate, sulfate, nitrate or oxide components such as Na₂CO₃, K₂CO₃, CaCO₃, MgCO₃, Na₂SO₄, Al₂(SO₄)₃, BaSO₄, KNO₃, Mg(NO₃)₂, Al(NO₃)₃, Na₂O, K₂O, and Li₂O.

Such porous oxides have various properties depending on the type and preparation process thereof. The carrier suitable for use in the invention has a particle diameter of 0.2 to 300 μm, preferably 1 to 200 μm, a specific surface area within the range of 50 to 1200 m²/g, preferably 100 to 1000 m²/g, and desirably has a pore volume within the range of 0.3 to 30 cm³/g. Such a carrier is used after, according to need, being calcined at 100 to 1000° C., and preferably 150 to 700° C.

As said inorganic chlorides, MgCl₂, MgBr₂, MnCl₂, MnBr₂ and so on are used. The inorganic chlorides may be used as received or after being pulverized with a ball mill, a vibration mill, or the like. It is also permitted to use one prepared by dissolving an inorganic chloride in a solvent such as alcohol and then precipitating it into the form of fine particles with a precipitating agent.

The clays for use in the present invention are generally composed of a clay mineral as the major component. The ion-exchanging layered compounds for use in the present invention are compounds that have a crystal structure in which planes formed by ionic bonding or the like pile on one another in parallel with weak bond strength, ion contained therein being exchangeable. Most clay minerals are ion-exchanging layered compounds. The clays, the clay minerals and the ion-exchanging layered compounds are not limited to naturally occurring materials and synthetic ones may also be used.

Examples of said ion crystalline compounds include ion crystalline compounds having a layered crystal structure such as a hexagonal closest packing type, an antimony type, a CdCl₂ type, and a CdI₂ type.

Examples of such clays and clay minerals include kaolin, bentonite, kibushi clay, potter's clay, allophane, hisingerite, pyrophyllite, mica group, montmorillonite group, vermiculite, chlorite group, palygorskite, kaolinite, nacrite, dickite, and halloysite; examples of such ion-exchanging layered compounds include crystalline acid salts of polyvalent metals, such as α-Zr(HAsO₄)₂.H₂O, α-Zr(HPO₄)₂, α-Zr(KPO₄)₂.3H₂O, α-Ti(HPO₄)₂, α-Ti(HAsO₄)₂.H₂O, α-Sn(HPO₄)₂.H₂O, γ-Zr(HPO₄)₂, γ-Ti(HPO₄)₂, and γ-Ti(NH₄PO₄)₂.H₂O.

Such clays, clay minerals and ion-exchanging layered compounds are preferably those having a pore volume of 0.1 cc/g or more, more preferably of from 0.3 to 5 cc/g by the mercury penetration method wherein the pore has a radius of not less than 20 Å. The pore volume is measured for the range of pore diameter of from 20 to 3×104 Å by the mercury penetration method using a mercury porosimeter.

When a material having a pore volume of less than 0.1 cc/g wherein the pore has a radius of not less than 20 Å is used as a carrier, it tends to be difficult to obtain high polymerization activity.

It is also preferable to use a chemically treated clay or clay mineral. Examples of the chemical treatment include a surface treatment to remove impurities attached to a clay surface or a treatment to affect the crystal structure of the clay. Specific examples of such chemical treatment include acid treatment, alkali treatment, salt treatment, and organic matter treatment. The acid treatment removes impurities from the clay surface and increases the surface area of the clay by eluting cations such as those of Al, Fe and Mg contained in the crystal structure. The alkali treatment destroys the crystal structure of the clay, so that the structure of the clay changes. The salt treatment and the organic matter treatment produce an anionic complex, a molecular complex, an organic derivative, or the like to cause change in the surface area or the interlayer distance of the clay.

The ion-exchanging layered compound for use in the present invention may be a layered compound enlarged in interlayer distance by exchanging the exchangeable ions located between layers with other larger and bulkier ions by utilizing ion exchange properties. Such bulkier ions play a pillar-like role to support the layered structure and are generally called pillars. Such introduction of other substances to between layers of a layered compound is called intercalation. Examples of guest compounds to be intercalated include cationic inorganic compounds such as TiCl₄ and ZrCl₄; metal alkoxides such as Ti(OR)₄, Zr(OR)₄, PO(OR)₃, and B(OR)₃ (R is a hydrocarbon group or the like); and metal hydroxide ions such as [Al₁₃O₄(OH)₂₄]⁷⁺, [Zr₄(OH)₁₄]²⁺, and [Fe₃O(OCOCH₃)₆]⁺. These compounds may be used singly or two or more species thereof may be used in combination. Intercalation of such compounds can be carried out in the presence of polymers obtained by the hydrolysis of metal alkoxides such as Si(OR)₄, Al(OR)₃, and Ge(OR)₄ (R is a hydrocarbon group or the like) or in the presence of colloidal inorganic compounds such as SiO₂. Examples of such pillars include oxides resulting from thermal dehydration of the above-mentioned metal hydroxide ions intercalated to between layers.

The clays, clay minerals, and ion-exchanging layered compounds for use in the present invention may be used as received, or alternatively clays, clay minerals, and ion-exchanging layered compounds treated, for example, by ball milling or sieving may be used. It is also allowed to use clays, clay minerals, and ion-exchanging layered compounds after applying addition and adsorption of water or applying heating and dehydration treatment. They may be used singly or two or more species thereof may be used in combination.

Of these, the clays and the clay minerals are preferred, and montmorillonite, vermiculite, pectolite, taeniolite, and synthetic mica are particularly preferred.

Examples of an organic compound suitable as a solid state carrier to be use for the component (b) include a particulate solid having a particle diameter of 10 to 300 μm. Specific examples thereof include (co)polymers mainly composed of an olefin having 2 to 14 carbon atoms such as ethylene, propylene, 1-butene, or 4-methyl-1-pentene, (co)polymers mainly composed of vinylcyclohexane or styrene, and modified products thereof.

When component (a) and component (b) are brought into contact with each other, a reaction site in the component (a) and a reaction site in the component (b) react together to form a chemical bond and, as a result, a contact product of the component (a) and the component (b) is formed. The time of the contact of the component (a) and the component (b) is usually up to 20 hours, and preferably up to 10 hours and the contact temperature is usually from −50 to 200° C., and preferably from −20 to 120° C. If the initial contact between the components (a) and (b) takes place sharply, the reaction heat or reaction energy breaks the component (b) to cause a deteriorated morphology of the obtainable solid state catalyst component, and the use of such a component in polymerization will result in difficulty in continuous operation due to bad morphology of the polymer. Thus, the initial contact of the components (a) and (b) is preferably performed at a low temperature or the components are caused to react together slowly to avoid the generation of reaction heat. Although the molar ratio of the component (a) to the component (b) in bringing the component (a) and the component (b) into contact with each other (component (a)/component (b)) can be chosen arbitrarily, a higher molar ratio is preferred because this allows the contact product to support an increased amount of a transition metal complex (A1) and a transition metal complex (A2) and can improve the activity per solid state catalyst component.

The ratio component (a)/component (b) is preferably from 0.2 to 2.0, and particularly preferably from 0.4 to 2.0.

Component (B-1) is preferably a solid state catalyst component formed by bringing an organoaluminumoxy compound and silica into contact with each other and more preferably is a solid state catalyst component formed by bringing a cyclic aluminoxane represented by the above formula [1] or a linear aluminoxane represented by the above formula [2] and silica into contact with each other.

Component (B-2) is a modified clay mineral formed by bringing an organic compound and a clay mineral into contact with each other. Examples of such a clay mineral include those that have been provided as examples of the clay mineral of the above-described component (b).

Examples of the organic compound to be used for the component (B-2) include compounds represented by the following formula [3], the following formula [4], or the following formula [5]. Out of these, preferred are the compounds represented by the following formula [3].

[R⁸R⁹ₓ₋₁M³H]m₁[A¹]n₁ [3]

wherein [A¹] represents an anion, [R⁸R⁹ₓ₁M³H] represents a cation, M³ represents an atom of Group 15 or Group 16 of the periodic table of the elements, R⁸ represents a hydrocarbon group, and R⁹ each independently represents a hydrogen atom or a hydrocarbon group; x represents 3 when M³ is an element of Group 15 and it represents 2 when M³ is an element of Group 16; m1 and n1 represent integers selected so that charges might be balanced.

[C]m₂[A²]₂ [4]

wherein [A²] represents an anion and [C] represents a carbonium cation or a tropylium cation; m2 and n2 represent integers selected so that charges might be balanced.

[M⁴L³_{y}]m₃[A³]n₃ [5]

wherein [A³] represents an anion, M⁴ represents a cation of a lithium atom, an iron atom, or a silver atom, and L³ each independently represents a Lewis base or a substituted or non-substituted cyclopentadienyl group; y satisfies 0≦y≦2; m3 and n3 represent integers selected so that charges might be balanced.

Examples of the anion of A¹ through A³ include a fluorine ion, a chlorine ion, a bromine ion, an iodine ion, a sulfate ion, a nitrate ion, a phosphate ion, a perchlorate ion, an oxalate ion, a citrate ion, a succinate ion, a tetrafluoroborate ion, and a hexafluorophosphate ion. Examples of the atom of M³ of Group 15 of the periodic table of the elements include a nitrogen atom and a phosphorus atom. Examples of the atom of M³ of Group 16 of the periodic table of the elements include an oxygen atom and a sulfur atom. Preferred as the hydrocarbon groups of R⁸ and R⁹ of M³ are hydrocarbon groups having 1 to 20 carbon atoms. Examples of said hydrocarbon groups having 1 to 20 carbon atoms include a methyl group, an ethyl group, a n-propyl group, an isopropyl group, an allyl group, a n-butyl group, an isobutyl group, a sec-butyl group, a tert-butyl group, a n-pentyl group, an isopentyl group, a 2-methylbutyl group, a 1-methylbutyl group, a 1-ethylpropyl group, a neopentyl group, a tert-pentyl group, a cyclopentyl group, a n-hexyl group, an isohexyl group, a 3-methylpentyl group, a 4-methyl pentyl group, a neohexyl group, a 2,3-dimethylbutyl group, a 2,2-dimethylbutyl group, a 4-methyl-2-pentyl, a 3,3-dimethyl-2-butyl group, a 1,1-dimethylbutyl group, a 2,3-dimethyl-2-butyl group, a cyclohexyl group, a n-heptyl group, a cycloheptyl group, a 2-methylcyclohexyl group, a 3-methylcyclohexyl group, a 4-methylcyclohexyl group, a n-octyl group, an isooctyl group, a 1,5-dimethylhexyl group, a 1-methyl heptyl group, a 2-ethylhexyl group, a tert-octyl group, a 2,3-dimethylcyclohexyl group, a 2-(1-cyclohexenyl)ethyl group, a n-nonyl group, a n-decyl group, an isodecyl group, a geranyl group, a n-undecyl group, a n-dodecyl group, a cyclododecyl group, a n-tridecyl group, a n-tetradecyl group, a n-pentadecyl group, a n-hexadecyl group, a n-heptadecyl group, a n-octadecyl group, a n-nonadecyl group, a n-eicosyl group, a n-heneicosyl group, a n-docosyl group, a n-tricosyl group, an oleyl group, a behenyl group, a phenyl group, an o-tolyl group, a m-tolyl group, a p-tolyl group, a 2-ethylphenyl group, a 3-ethylphenyl group, a 4-ethylphenyl group, a 2-isopropylphenyl group, a 3-isopropyl phenyl group, a 4-isopropyl phenyl group, a 2-tert-butylphenyl group, a 4-n-butylphenyl group, a 4-sec-butylphenyl group, a 4-tert-butylphenyl group, a 2,3-xylyl group, a 2,4-xylyl group, a 2,5-xylyl group, a 2,6-xylyl group, a 3,4-xylyl group, a 3,5-xylyl group, a 2,6-diethylphenyl group, a 2-isopropyl-6-methylphenyl group, a 2-chlorophenyl group, a 3-chlorophenyl group, a 4-chlorophenyl group, a 2-bromophenyl group, a 3-bromophenyl group, a 4-bromophenyl group, a 2-methoxyphenyl group, a 3-methoxyphenyl group, a 4-methoxyphenyl group, a 2-ethoxy phenyl group, a 3-ethoxyphenyl group, a 4-ethoxy phenyl group, a 1-naphthyl group, a 2-naphthyl group, a 1-fluorenyl group, a 2-fluorenyl group, a 3-fluorenyl group, a 4-fluorenyl group, a 2,3-dihydroinden-5-yl group, a 2-biphenyl group, a 4-biphenyl group, and a p-trimethylsilylphenyl group. Out of the compounds represented by the above formula [3], examples of compounds with M³ being a nitrogen atom include aliphatic amine hydrochlorides such as methylamine hydrochloride, ethylamine hydrochloride, n-propylamine hydrochloride, isopropylamine hydrochloride, n-butylamine hydrochloride, isobutylamine hydrochloride, tert-butylamine hydrochloride, n-pentylamine hydrochloride, isopentylamine hydrochloride, 2-methylbutylamine hydrochloride, neopentylamine hydrochloride, tert-pentylamine hydrochloride, n-hexylamine hydrochloride, isohexylamine hydrochloride, n-heptylamine hydrochloride, n-octylamine hydrochloride, n-nonylamine hydrochloride, n-decylamine hydrochloride, n-undecylamine hydrochloride, n-dodecylamine hydrochloride, n-tetradecylamine hydrochloride, n-hexadecylamine hydrochloride, n-octadecylamine hydrochloride, allylamine hydrochloride, cyclopentylamine hydrochloride, dimethylamine hydrochloride, diethylamine hydrochloride, diallylamine hydrochloride, trimethylamine hydrochloride, tri-n-butylamine hydrochloride, triallylamine hydrochloride, hexylamine hydrochloride, 2-aminoheptane hydrochloride, 3-aminoheptane hydrochloride, n-heptylamine hydrochloride, 1,5-dimethylhexylamine hydrochloride, 1-methylheptylamine hydrochloride, n-octylamine hydrochloride, tert-octylamine hydrochloride, nonylamine hydrochloride, decylamine hydrochloride, undecylamine hydrochloride, dodecylamine hydrochloride, tridecylamine hydrochloride, tetradecylamine hydrochloride, pentadecylamine hydrochloride, hexadecylamine hydrochloride, heptadecylamine hydrochloride, octadecylamine hydrochloride, nonadecylamine hydrochloride, cyclohexylamine hydrochloride, cycloheptylamine hydrochloride, 2-methylcyclohexylamine hydrochloride, 3-methylcyclohexylamine hydrochloride, 4-methylcyclohexylamine hydrochloride, 2,3-dimethylcyclohexylamine hydrochloride, cyclododecylamine hydrochloride, 2-(1-cyclohexenyl)ethylamine hydrochloride, geranylamine hydrochloride, N-methylhexylamine hydrochloride, dihexylamine hydrochloride, bis(2-ethylhexyl)amine hydrochloride, dioctylamine hydrochloride, didecylamine hydrochloride, N-methylcyclohexylamine hydrochloride, N-ethylcyclohexylamine hydrochloride, N-isopropylcyclohexylamine hydrochloride, N-tert-butylcyclohexylamine hydrochloride, N-allylcyclohexylamine hydrochloride, N,N-dimethyloctylamine hydrochloride, N,N-dimethylundecylamine hydrochloride, N,N-dimethyldodecylamine hydrochloride, N,N-dimethyl-n-tetradecylamine hydrochloride, N,N-dimethyl-n-hexadecylamine hydrochloride, N,N-dimethyl-n-octadecylamine hydrochloride, N,N-dimethyl-n-eicosylamine hydrochloride, N,N-dimethyl-n-docosylamine hydrochloride, N,N-dimethyloleylamine hydrochloride, N,N-dimethylbehenylamine hydrochloride, trihexylamine hydrochloride, triisooctylamine hydrochloride, trioctylamine hydrochloride, triisodecylamine hydrochloride, tridodecylamine hydrochloride, N-methyl-N-octadecyl-1-octadecylamine hydrochloride, N,N-dimethylcyclohexylamine hydrochloride, N,N-dimethylcyclohexylmethylamine hydrochloride, N,N-diethylcyclohexylamine hydrochloride, pyrrolidine hydrochloride, piperidine hydrochloride, 2,5-dimethylpyrrolidine hydrochloride, 2-methylpiperidine hydrochloride, 3-methylpiperidine hydrochloride, 4-methylpiperidine hydrochloride, 2,6-dimethylpiperidine hydrochloride, 3,3-dimethylpiperidine hydrochloride, 3,5-dimethylpiperidine hydrochloride, 2-ethylpiperidine hydrochloride, 2,2,6,6-tetramethylpiperidine hydrochloride, 1-methylpyrrolidine hydrochloride, 1-methylpiperidine hydrochloride, 1-ethylpiperidine hydrochloride, 1-butylpyrrolidine hydrochloride, 1,2,2,6,6-pentamethylpiperidine hydrochloride; aromatic amine hydrochlorides such as aniline hydrochloride, N-methylaniline hydrochloride, N-ethylaniline hydrochloride, N-allylaniline hydrochloride, o-toluidine hydrochloride, m-toluidine hydrochloride, p-toluidine hydrochloride, N,N-dimethylaniline hydrochloride, N-methyl-o-toluidine hydrochloride, N-methyl-m-toluidine hydrochloride, N-methyl-p-toluidine hydrochloride, N-ethyl-o-toluidine hydrochloride, N-ethyl-m-toluidine hydrochloride, N-ethyl-p-toluidine hydrochloride, N-allyl-o-toluidine hydrochloride, N-allyl-m-toluidine hydrochloride, N-allyl-p-toluidine hydrochloride, N-propyl-o-toluidine hydrochloride, N-propyl-m-toluidine hydrochloride, N-propyl-p-toluidine hydrochloride, 2,3-dimethylaniline hydrochloride, 2,4-dimethylaniline hydrochloride, 2,5-dimethylaniline hydrochloride, 2,6-dimethylaniline hydrochloride, 3,4-dimethylaniline hydrochloride, 3,5-dimethylaniline hydrochloride, 2-ethylaniline hydrochloride, 3-ethylaniline hydrochloride, 4-ethylaniline hydrochloride, N,N-diethylaniline hydrochloride, 2-isopropylaniline hydrochloride, 4-isopropylaniline hydrochloride, 2-tert-butylaniline hydrochloride, 4-n-butylaniline hydrochloride, 4-sec-butylaniline hydrochloride, 4-tert-butylaniline hydrochloride, 2,6-diethylaniline hydrochloride, 2-isopropyl-6-methylaniline hydrochloride, 2-chloroaniline hydrochloride, 3-chloroaniline hydrochloride, 4-chloroaniline hydrochloride, 2-bromoaniline hydrochloride, 3-bromoaniline hydrochloride, 4-bromoaniline hydrochloride, o-anisidine hydrochloride, m-anisidine hydrochloride, p-anisidine hydrochloride, o-phenetidine hydrochloride, m-phenetidine hydrochloride, p-phenetidine hydrochloride, 1-aminonaphthalene hydrochloride, 2-aminonaphthalene hydrochloride, 1-aminofluorene hydrochloride, 2-aminofluorene hydrochloride, 3-aminofluorene hydrochloride, 4-aminofluorene hydrochloride, 5-aminoindan hydrochloride, 2-aminobiphenyl hydrochloride, 4-aminobiphenyl hydrochloride, N,2,3-trimethylaniline hydrochloride, N,2,4-trimethylaniline hydrochloride, N,2,5-trimethylaniline hydrochloride, N,2,6-trimethylaniline hydrochloride, N,3,4-trimethylaniline hydrochloride, N,3,5-trimethylaniline hydrochloride, N-methyl-2-ethylaniline hydrochloride, N-methyl-3-ethylaniline hydrochloride, N-methyl-4-ethylaniline hydrochloride, N-methyl-6-ethyl-o-toluidine hydrochloride, N-methyl-2-isopropylaniline hydrochloride, N-methyl-4-isopropylaniline hydrochloride, N-methyl-2-tert-butylaniline hydrochloride, N-methyl-4-n-butylaniline hydrochloride, N-methyl-4-sec-butylaniline hydrochloride, N-methyl-4-tert-butylaniline hydrochloride, N-methyl-2,6-diethylaniline hydrochloride, N-methyl-2-isopropyl-6-methylaniline hydrochloride, N-methyl-p-anisidine hydrochloride, N-ethyl-2,3-anisidine hydrochloride, N,N-dimethyl-o-toluidine hydrochloride, N,N-dimethyl-m-toluidine hydrochloride, N,N-dimethyl-p-toluidine hydrochloride, N,N,2,3-tetramethylaniline hydrochloride, N,N,2,4-tetramethylaniline hydrochloride, N,N,2,5-tetramethylaniline hydrochloride, N,N,2,6-tetramethylaniline hydrochloride, N,N,3,4-tetramethylaniline hydrochloride, N,N,3,5-tetramethylaniline hydrochloride, N,N-dimethyl-2-ethylaniline hydrochloride, N,N-dimethyl-3-ethylaniline hydrochloride, N,N-dimethyl-4-ethylaniline hydrochloride, N,N-dimethyl-6-ethyl-o-toluidine hydrochloride, N,N-dimethyl-2-isopropylaniline hydrochloride, N,N-dimethyl-4-isopropylaniline hydrochloride, N,N-dimethyl-2-tert-butylaniline hydrochloride, N,N-dimethyl-4-n-butylaniline hydrochloride, N,N-dimethyl-4-sec-butylaniline hydrochloride, N,N-dimethyl-4-tert-butylaniline hydrochloride, N,N-dimethyl-2,6-diethylaniline hydrochloride, N,N-dimethyl-2-isopropyl-6-methylaniline hydrochloride, N,N-dimethyl-2-chloroaniline hydrochloride, N,N-dimethyl-3-chloroaniline hydrochloride, N,N-dimethyl-4-chloroaniline hydrochloride, N,N-dimethyl-2-bromoaniline hydrochloride, N,N-dimethyl-3-bromoaniline hydrochloride, N,N-dimethyl-4-bromoaniline hydrochloride, N,N-dimethyl-o-anisidine hydrochloride, N,N-dimethyl-m-anisidine hydrochloride, N,N-dimethyl-p-anisidine hydrochloride, N,N-dimethyl-o-phenetidine hydrochloride, N,N-dimethyl-m-phenetidine hydrochloride, N,N-dimethyl-p-phenetidine hydrochloride, N,N-dimethyl-1-aminonaphthalene hydrochloride, N,N-dimethyl-2-aminonaphthalene hydrochloride, N,N-dimethyl-1-aminofluorene hydrochloride, N,N-dimethyl-2-aminofluorene hydrochloride, N,N-dimethyl-3-aminofluorene hydrochloride, N,N-dimethyl-4-aminofluorene hydrochloride, N,N-dimethyl-5-aminoindan hydrochloride, N,N-dimethyl-2-aminobiphenyl hydrochloride, N,N-dimethyl-4-aminobiphenyl hydrochloride, and N,N-dimethyl-p-trimethylsilylaniline hydrochloride; and compounds in which the hydrochloride of the above compounds has been substituted with hydrofluoride, hydrobromide, hydroiodide or sulfate.

Of the compounds represented by the above formula [3], examples of the compound wherein M³ is a phosphor atom include such compounds as triphenylphosphine hydrochloride, tri(o-tolyl)phosphine hydrochloride, tri(p-tolyl)phosphine hydrochloride, and trimesylphosphine hydrochloride; and compounds in which the hydrochloride of the above compounds has been substituted with hydrofluoride, hydrobromide, hydroiodide or sulfate.

Of the compounds represented by the above formula [3], examples of the compound wherein M³ is an oxygen atom include such compounds as methyl ether hydrochloride, ethyl ether hydrochloride, n-butyl ether hydrochloride, tetrahydrofuran hydrochloride, and phenyl ether hydrochloride; and compounds in which the hydrochloride of the above compounds has been substituted with hydrofluoride, hydrobromide, hydroiodide or sulfate.

Of the compounds represented by the above formula [3], examples of the compound wherein M³ is a sulfur atom include diethyl sulfonium fluoride, diethyl sulfonium chloride, diethyl sulfonium bromide, diethyl sulfonium iodide, dimethyl sulfonium fluoride, dimethyl sulfonium chloride, dimethyl sulfonium bromide, and dimethyl sulfonium iodide.

Examples of the compound represented by the above formula [4] include trityl bromide, trityl chloride, trityl tetrafluoroborate, trityl hexafluorophosphate, tropylium bromide, tropylium chloride, tropylium tetrafluoroborate, and tropylium hexafluorophosphate.

Examples of the Lewis base of L³ include ethers, aliphatic amines, aromatic amines, and phosphines.

Examples of the compound represented by the above formula [5] include ferrocenium bromide, ferrocenium chloride, ferrocenium tetrafluoroborate, and ferrocenium hexafluorophosphate.

In the contact of the organic compound with the clay mineral in component (B-2), it is preferable to bring them into contact with each other while choosing a clay mineral concentration of from 0.1 to 30% by weight and a contact temperature of from 0 to 150° C. As to the organic compound, a solution in which a solid organic compound is dissolved in a solvent may be used, or alternatively a solution of an organic compound formed via a chemical reaction in a solvent may be used as it is. As to the reaction amount ratio between the clay mineral and the organic compound, it is preferable to use the organic compound in an amount equivalent or more to the exchangeable cation in the clay mineral. Examples of the contact solvent include aliphatic hydrocarbons, aromatic hydrocarbons, alcohols, ethers, halogenated hydrocarbons, ketones, and water. Examples of the aliphatic hydrocarbons include pentane, hexane, and heptane. Examples of the aromatic hydrocarbons include benzene and toluene. Examples of the alcohols include ethanol and methanol. Examples of the ethers include ethyl ether, n-butyl ether, tetrahydrofuran, and 1,4-dioxane. Examples of the halogenated hydrocarbons include methylene chloride, and chloroform. Examples of the ketones include acetone.

Such contact solvents may be used singly or two or more species thereof may be used in combination. Among such contact solvents, preferred is an alcohol or water.

As the component (B), preferred is a solid state catalyst component formed by bringing an organoaluminumoxy compound and silica into contact with each other or a modified clay mineral formed by bringing an organic compound and a clay mineral into contact with each other, more preferred is a solid state catalyst component formed by bringing an organoaluminumoxy compound and silica into contact with each other or a modified clay mineral formed by bringing a compound represented by the above formula [3], the above formula [4], or the above formula [5] and a clay mineral into contact with each other, even more preferred is a solid state catalyst component formed by bringing an organoaluminumoxy compound and silica into contact with each other, and particularly preferred is a solid state catalyst component formed by bringing a cyclic aluminoxane represented by the above formula [1] or a linear aluminoxane represented by the above formula [2] and silica into contact with each other.

Examples of the organoaluminum compound of component (C) include trialkylaluminums, dialkylaluminum chlorides, alkylaluminum dichlorides, dialkylaluminum hydrides, alkyl(dialkoxy)aluminums, dialkyl(alkoxy)aluminums, alkyl(diaryloxy)aluminums, and dialkyl(aryloxy)aluminums.

Examples of said trialkylaluminiums include trimethylaluminum, triethylaluminum, tri-n-propylaluminum, tri-n-butylaluminum, triisobutylaluminum, tri-n-hexylaluminum, and tri-n-octylaluminum; examples of said dialkylaluminum chlorides include dimethylaluminum chloride, diethylaluminum chloride, di-n-propylaluminum chloride, di-n-butylaluminum chloride, diisobutylaluminum chloride, and di-n-hexylaluminum chloride; examples of said alkylaluminum dichlorides include methylaluminum dichloride, ethylaluminum dichloride, n-propylaluminum dichloride, n-butylaluminum dichloride, isobutylaluminum dichloride, and n-hexylaluminum dichloride; examples of said dialkylaluminum hydrides include dimethylaluminum hydride, diethylaluminum hydride, di-n-propylaluminum hydride, di-n-butylaluminum hydride, diisobutylaluminum hydride, and di-n-hexylaluminum hydride; examples of said alkyl(dialkoxy)aluminums include methyl(dimethoxy)aluminum, methyl(diethoxy)aluminum, and methyl(di-tert-butoxy)aluminum; examples of said dialkyl(alkoxy)aluminums include dimethyl(methoxy)aluminum, dimethyl(ethoxy)aluminum, and methyl(tert-butoxy)aluminum; examples of said alkyl(diaryloxy)aluminums include methyl(diphenoxy)aluminum, methylbis(2,6-diisopropylphenoxy)aluminum, and methylbis(2,6-diphenylphenoxy)aluminum; examples of said dialkyl(aryloxy)aluminums include dimethyl(phenoxy)aluminum, dimethyl(2,6-diisopropylphenoxy)aluminum, and dimethyl(2,6-diphenylphenoxy)aluminum.

As to such organoaluminum compounds, only a single species may be used or two or more species may be used in combination.

Preferred as the organoaluminum compound are trialkylaluminiums, more preferred are trimethylaluminum, triethylaluminum, tri-n-butylaluminum, triisobutylaluminum, tri-n-hexylaluminum, and tri-n-octylaluminum, and even more preferred are triisobutylaluminum and tri-n-octylaluminum.

The amount of component (C) used, expressed by the ratio (C)/((A1)+(A2)) of the number of moles of the aluminum atoms of the organoaluminum compound of component (C) to the combined number of moles of the transition metal atoms of components (A1) and (A2), is preferably from 0.01 to 10,000, more preferably from 0.1 to 5,000, and most preferably from 1 to 2,000.

In the production of the above-described catalyst, an electron donating compound (component (D)) may be used. As such an electron donating compound, preferred are compounds containing a nitrogen atom, a phosphorus atom, an oxygen atom, or a sulfur atom, examples of which include oxygen-containing compounds, nitrogen-containing compounds, phosphorus-containing compounds, and sulfur-containing compounds, and an oxygen-containing compound or a nitrogen-containing compound is particularly preferred. Examples of such oxygen-containing compounds include alkoxysilanes, ethers, ketones, aldehydes, carboxylic acids, esters of organic acids or inorganic acids, acid amides of organic acids or inorganic acids, and acid anhydrides; alkoxysilanes or ethers are particularly preferred. Examples of such nitrogen-containing compounds include amines, nitriles, and isocyanates; amines are preferred.

Preferred as such alkoxysilanes are compounds represented by the following formula [6]:

R¹⁰ₖSi(OR¹¹)₄₋ₖ [6]

wherein R¹⁰ represents a hydrocarbon group having 1 to 20 carbon atoms, a hydrogen atom, or a hetero atom-containing substituent, R¹¹ represents a hydrocarbon group having 1 to 20 carbon atoms, and k represents an integer that satisfies 0≦k≦3; when there are two or more R¹⁰ groups, the R¹⁰ groups may be the same or different, and when there are two or more OR¹¹ groups, the OR¹¹ groups may be the same or different.

Examples of the hydrocarbon groups having 1 to 20 carbon atoms of R¹⁰ and R¹¹ include linear alkyl groups, such as a methyl group, an ethyl group, a propyl group, a butyl group, and a pentyl group, branched chain alkyl groups, such as an isopropyl group, a sec-butyl group, a tert-butyl group, and a tert-amyl group, cycloalkyl groups, such as a cyclopentyl group and a cyclohexyl group, cycloalkenyl groups, such as a cyclopentenyl group, aryl groups, such as a phenyl group and a tolyl group.

Examples of the hetero atom of the hetero atom-containing substituent of R¹⁰ include an oxygen atom, a nitrogen atom, a sulfur atom, and a phosphorus atom. Specific examples include a dimethylamino group, a methylethylamino group, a diethylamino group, an ethyl-n-propyl amino group, a di-n-propylamino group, a pyrrolyl group, a pyridyl group, a pyrrolidinyl group, a piperidyl group, a perhydroindolyl group, a perhydroisoindolyl group, a perhydroquinolyl group, a perhydroisoquinolyl group, a perhydrocarbazolyl group, a perhydroacridinyl group, a furyl group, a pyranyl group, a perhydrofuryl group, and a thienyl group. Preferably, R¹⁰ and R¹¹ are alkyl groups, and more preferably, R¹⁰ and R¹¹ are alkyl groups and i is 2 or 3.

Examples of said alkoxysilanes include tetramethoxysilane, methyltrimetoxysilane, ethyltrimethoxysilane, n-propyltrimethoxysilane, isopropyltrimethoxysilane, n-butyltrimethoxysilane, isobutyltrimethoxysilane, sec-butyltrimethoxysilane, tert-butyltrimethoxysilane, n-pentyltrimethoxysilane, tert-amyltrimethoxysilane, dimethyldimethoxysilane, diethyldimethoxysilane, di-n-butyldimethoxysilane, diisobutyldimethoxysilane, di-tert-butyldimethoxysilane, methylethyldimethoxysilane, methyl-n-propyldimethoxysilane, methyl-n-butyldimethoxysilane, methylisobutyldimethoxysilane, tert-butylmethyldimethoxysilane, tert-butylethyldimethoxysilane, tert-butyl-n-propyldimethoxysilane, tert-butylisopropyldimethoxysilane, tert-butyl-n-butyl dimethoxysilane, tert-butylisobutyldimethoxysilane, tert-amylmethyldimethoxysilane, tert-amylethyldimethoxysilane, tert-amyl-n-propyldimethoxysilane, tert-amyl-n-butyldimethoxysilane, isobutylisopropyldimethoxysilane, dicyclobutyldimethoxysilane, cyclobutylmethyldimethoxysilane, cyclobutylethyldimethoxysilane, cyclobutylisopropyldimethoxysilane, cyclobutyl-n-butyldimethoxysilane, cyclobutylisobutyldimethoxysilane, cyclobutyl-tert-butyldimethoxysilane, dicyclopenthyldimetoxysilane, cyclopentylmethyldimethoxysilane, cyclopentyl-n-propyldimethoxysilane, cyclopentylisopropyldimethoxysilane, cyclopentyl-n-butyldimethoxysilane, cyclopentylisobutyldimethoxysilane, cyclopentyl-tert-butyldimethoxysilane, dicyclohexyldimetoxysilane, cyclohexylmethyldimetoxysilane, cyclohexylethyldimethoxysilane, cyclohexyl-n-propyldimethoxysilane, cyclohexylisopropyldimethoxysilane, cyclohexyl-n-butyldimethoxysilane, cyclohexylisobutyldimethoxysilane, cyclohexyl-tert-butyldimethoxysilane, cyclohexylcyclopentyldimethoxysilane, cyclohexylphenyldimethoxysilane, diphenyldimethoxysilane, phenylmethyldimethoxysilane, phenylethyldimethoxysilane, phenyl-n-propyldimethoxysilane, phenylisopropyldimethoxysilane, phenyl-n-butyldimethexysilane, phenylisobutyldimethexysilane, phenyl-tert-butyldimethoxysilane, phenylcyclopentyldimethoxysilane, 2-norbornanemethyldimethoxysilane, bis(perhydroquinolino)dimethoxysilane, bis(perhydroisoquinolino)dimethoxysilane, (perhydroquinolino)(perhydroisoquinolino)dimethoxysilane, (perhydroquinolino)methyldimethoxysilane, (perhydroisoquinolino)methyldimethoxysilane, (perhydroquinolino)ethyldimethoxysilane, (perhydroisoquinolino)ethyldimethoxysilane, (perhydroquinolino)(n-propyl)dimethoxysilane, (perhydroisoquinolino)(n-propyl)dimethoxysilane, (perhydroquinolino)(tert-butyl)dimethoxysilane, (perhydroisoquinolino)(tert-butyl)dimethoxysilane, trimethylmethoxysilane, triethylmethoxysilane, tri-n-propylmethoxysilane, triisopropylmethoxysilane, tri-n-butylmethoxysilane, triisobutylmethoxysilane, and tri-tert-butylmethoxysilane. Additional examples include compounds formed by changing “methoxy” contained in the above compounds to “ethoxy”, “propoxy”, “n-butoxy”, “isobutoxy”, “tert-butoxy” or “phenoxy”. Preferred is a dialkyldialkoxysilane or a trialkylmonoalkoxysilane, and more preferred is a trialkylmonoalkoxysilane.

Examples of said ethers include dialkyl ethers, alkyl aryl ethers, diaryl ethers, diether compounds, cyclic ethers, and cyclic diethers.

Specific examples thereof include dimethyl ether, diethyl ether, di-n-propyl ether, diisopropyl ether, di-n-butyl ether, diisobutyl ether, di-tert-butyl ether, dicyclohexyl ether, diphenyl ether, methyl ethyl ether, methyl n-propyl ether, methyl isopropyl ether, methyl n-butyl ether, methyl isobutyl ether, methyl tert-butyl ether, methyl cyclohexyl ether, methyl phenyl ether, ethylene oxide, propylene oxide, oxetane, tetrahydrofuran, 2,5-dimethyltetrahydrofuran, tetrahydropyran, 1,2-dimethoxyethane, 1,2-diethoxyethane, 1,2-diisobutoxyethane, 2,2-dimethoxypropane, 1,3-dimethoxypropane, 2,2-diisobutyl-1,3-dimethoxypropane, 2-isopropyl-2-isopentyl-1,3-dimethoxypropane, 2,2-bis(cyclohexylmethyl)-1,3-dimethoxypropane, 2-isopropyl-2-3,7-dimethyloctyl-1,3-dimethoxypropane, 2,2-diisopropyl-1,3-dimethoxypropane, 2-isopropyl-2-cyclohexylmethyl-1,3-dimethoxypropane, 2,2-dicyclohexyl-1,3-dimethoxypropane, 2-isopropyl-2-isobutyl-1,3-dimethoxypropane, 2,2-diisopropyl-1,3-dimethoxypropane, 2,2-dipropyl-1,3-dimethoxypropane, 2-isopropyl-2-cyclohexyl-1,3-dimethoxypropane, 2-isopropyl-2-cyclopentyl-1,3-dimethoxypropane, 2,2-dicyclopentyl-1,3-dimethoxypropane, 2-heptyl-2-pentyl-1,3-dimethoxypropane, 1,2-dimethoxybenzene, 1,3-dimethoxybenzene, 1,4-dimethoxybenzene, 1,3-dioxolane, 1,4-dioxane, and 1,3-dioxane. Preferred is diethyl ether, di-n-butyl ether, methyl n-butyl ether, methyl phenyl ether, tetrahydrofuran, 1,3-dioxane, 1,4-dioxane or 1,3-dioxolan, and more preferred is diethyl ether, di-n-butyl ether or tetrahydrofuran.

Specific examples of the esters of carboxylic acids include esters of mono- or poly-carboxylic acids, and examples thereof include saturated aliphatic carboxylates, unsaturated aliphatic carboxylates, alicyclic carboxylates, and aromatic carboxylates. Specific examples thereof include methyl acetate, ethyl acetate, n-butyl acetate, isobutyl acetate, tert-butyl acetate, phenyl acetate, methyl propionate, ethyl propionate, ethyl butylate, ethyl valerate, ethyl acrylate, methyl methacrylate, methyl benzoate, ethyl benzoate, n-butyl benzoate, isobutyl benzoate, tert-butyl benzoate, methyl toluate, ethyl toluate, methyl anisate, ethyl anisate, dimethyl succinate, diethyl succinate, di-n-butyl succinate, dimethyl malonate, diethyl malonate, di-n-butyl malonate, dimethyl maleate, dibutyl maleate, diethyl itaconate, di-n-butyl itaconate, monoethyl phthalate, dimethyl phthalate, methyl ethyl phthalate, diethyl phthalate, di-n-propyl phthalate, diisopropyl phthalate, di-n-butyl phthalate, diisobutyl phthalate, di-tert-butyl phthalate, dipentyl phthalate, di-n-hexyl phthalate, diheptyl phthalate, di-n-octyl phthalate, di-(2-ethylhexyl)phthalate, diisodecyl phthalate, dicyclohexyl phthalate, diphenyl phthalate, dimethyl isophthalate, diethyl isophthalate, di-n-butyl isophthalate, diisobutyl isophthalate, di-tert-butyl isophthalate, dimethyl terephthalate, diethyl terephthalate, di-n-butyl terephthalate, diisobutyl terephthalate, and di-tert-butyl terephthalate. Preferred is methyl acetate, ethyl acetate, methyl benzoate, ethyl benzoate, dimethyl phthalate, diethyl phthalate, di-n-butyl phthalate, diisobutyl phthalate, dimethyl terephthalate, or diethyl terephthalate, and more preferred is methyl benzoate, dimethyl phthalate, diethyl phthalate, diisobutyl phthalate, or dimethyl terephthalate.

Exemplary compounds of amines include trihydrocarbylamines, and examples thereof include trimethylamine, triethylamine, tripropylamine, tri-n-butylamine, triisobutylamine, trihexylamine, trioctylamine, tirdodecylamine, and triphenylamine. Preferred is triethylamine or trioctylamine.

As the above-mentioned electron donating compound (D), compounds having an active hydrogen can be used. Among such compounds having an active hydrogen, alcohols, phenols, carboxylic acids, thiols, thiophenols, thiocarboxylic acids, sulfonic acids, ammonia, primary amines, secondary amines, anilines, imines, amides, pyrroles, pyrrolidines, piperidines, hydroxyamines, and silanols may be used. Of these, compounds having an N—H bond are preferably used, ammonia, primary amines, secondary amines, anilines, pyrrolidines, or piperidines are more preferably used, and primary amines, secondary amines, or anilines are particularly preferably used.

Specific examples of primary amines include methyl amine, ethylamine, n-propylamine, isopropylamine, n-butylamine, isobutylamine, tert-butylamine, hexylamine, octylamine, and dodecylamine.

Specific examples of secondary amines include dimethylamine, diethylamine, di-n-propylamine, diisopropylamine, di-n-butylamine, diisobutylamine, di-tert-butylamine, dihexylamine, dioctylamine, didodecylamine, diphenylamine, and ethylmethylamine.

Anilines having an N—H bond can be used as said anilines, and specific examples thereof include aniline, N-methylaniline, N-ethylaniline, 4-methylaniline, and 2,6-dimethylaniline.

Pyrrolidines having an N—H bond can be used as said pyrrolidines, and specific examples thereof include pyrrolidine, 2,5-dimethylpyrrolidine, and 2,2,5,5-tetramethylpyrrolidine; piperidines having an N—H bond can be used as said piperidines, and specific examples thereof include piperidine, 4-methylpiperidine, 2,6-dimethylpiperidine, and 2,2,6,6-tetramethylpiperidine.

Among these exemplary compounds of such compounds having an active hydrogen, methylamine, ethylamine, dimethylamine, diethylamine, aniline, N-methylaniline, 2,5-dimethylpyrrolidine, or 2,6-dimethylpiperidine is used more preferably, and ethylamine, diethylamine, or N-methylaniline is used particularly preferably.

As the electron donor compound (D), an alkoxysilicon, an ether, or an amine is preferably used. Moreover, an amine is more preferably used. As to such electron donating compounds (D), only one species may be used or two or more species may be used in combination.

The ethylene-α-olefin copolymer of the present invention is obtained by copolymerizing ethylene and an α-olefin in the presence of a catalyst obtained using a transition metal complex (A1), a transition metal complex (A2), component (B), and component (C). When producing the catalyst, it is important how to bring the transition metal complex (A1) and the transition metal complex (A2) into contact with component (B). Component (C) may be brought into contact with the other components in any order.

The method for producing a catalyst for the production of an ethylene-α-olefin copolymer in the present invention may be a method of producing a catalyst for ethylene-α-olefin copolymerization, wherein the method involves bringing a transition metal complex (A1) and a transition metal complex (A2), component (B), and component (C) into contact with each other, the method preferably comprising a step of obtaining a contact mixture (X) by bringing the transition metal complex (A1) and the transition metal complex (A2) into contact with the component (B) uniformly as much as possible.

Examples of the method for obtaining the contact mixture (X) include a method comprising dissolving prescribed ratio of the transition metal complex (A1) and the transition metal complex (A2) in an inert solvent beforehand to prepare a mixed liquid in which both the complexes are mixed homogeneously, and then bringing the mixed liquid into contact with the component (B). It is also allowed to bring a mixed liquid of the transition metal complex (A1) and the transition metal complex (A2) into contact with a slurry in which the component (B) is dispersed in an inert solvent.

Specific examples of the inert solvent to be used for the preparation of a catalyst for the production of an ethylene-α-olefin copolymer include aliphatic hydrocarbons such as propane, butane, pentane, hexane, heptane, octane, decane, dodecane, and kerosene; alicyclic hydrocarbons such as cyclopentane, cyclohexane, and methylcyclopentane; aromatic hydrocarbons such as benzene, toluene, and xylene; halogenated hydrocarbons such as ethylene chloride, chlorobenzene, and dichloromethane; and mixtures thereof.

In the event that the transition metal complex (A1), the transition metal complex (A2), and the component (B) have been brought into contact with each other in the presence of an inert solvent, a contact mixture (X) is formed in the solvent. The contact mixture (X) contained in the solvent may be used as it is, or alternatively a powdery contact mixture (X) resulting from the removal of the solvent may be used. It is also allowed to use a slurry produced by mixing the powdery contact mixture (X) with a solvent.

In the case of polymerizing monomers using a contact mixture (X), the order to feed the monomers, the contact mixture (X), the component (C), and other components to a polymerization reactor is not particularly restricted, but a method in which polymerization is started by feeding a slurry or powdery contact mixture (X) to a polymerization reactor in which the monomers and the component (C) have been introduced is preferred.

Examples of the method for producing the ethylene-α-olefin copolymer of the present invention include a method of copolymerizing ethylene with an α-olefin by gas phase polymerization, slurry polymerization, bulk polymerization, or the like. Preferred is vapor phase polymerization, and more preferred is continuation vapor phase polymerization. The gas phase polymerization apparatus to be used for the polymerization method is usually an apparatus having a fluid bed type reaction vessel, preferably an apparatus having a fluid bed type reaction vessel with an enlarged part. A stirring blade may be mounted in the reaction vessel.

As a method of feeding a catalyst for polymerization and catalyst components into a polymerization reaction vessel, usually used is a method that involves feeding them using an inert gas such as nitrogen and argon, hydrogen, ethylene, and so on in a state containing no moisture, or a method that involves dissolving or diluting the respective components in a solvent, and feeding them in a solution or slurry state.

When ethylene and an α-olefin are vapor-polymerized, the polymerization temperature is usually lower than the temperature at which an ethylene-α-olefin copolymer is melted, preferably 0 to 150° C., and more preferably 30 to 100° C. Into a polymerization reaction vessel, an inert gas may be introduced and hydrogen may also be introduced as a molecular weight regulator. It is also allowed to introduce the component (C) and an electron donating compound (D).

The method for producing the ethylene-α-olefin polymer of the present invention is preferably a method comprising copolymerizing ethylene and an α-olefin using, as a catalyst component for polymerization or a catalyst for polymerization, a pre-polymerized solid component prepared by causing a small amount of an olefin to undergo polymerization (hereinafter referred to as prepolymerization) using a transition metal compound (A1), a transition metal compound (A2), component (B), component (C), and optionally the above-mentioned component (D).

Examples of the olefin to be used in the prepolymerization include ethylene, propylene, 1-butene, 1-pentene, 1-hexene, 1-octene, 4-methyl-1-pentene, cyclopentene, and cyclohexene. These may be used singly or two or more members of them may be used in combination. Preferably, only ethylene is used or ethylene is used together with an α-olefin, more preferably, only ethylene is used or ethylene is used together with at least one α-olefin selected from among 1-butene, 1-hexene, and 1-octene.

The content of a preliminarily polymerized polymer in a prepolymerization solid component is preferably 0.01 to 1000 g, more preferably 0.05 to 500 g, even more preferably 0.1 to 200 g per gram of component (B).

The prepolymerization method may be either a continuous polymerization method or a batch polymerization method, and is, for example, a batch slurry polymerization method, a continuous slurry polymerization method, or a continuous vapor polymerization method. In a prepolymerization method, as a method of feeding the contact mixture (X) prepared from the transition metal compound (A1), the transition metal compound (A2) and the component (B), the component (C), and optionally the component (D) into a polymerization reaction vessel where prepolymerization is to be conducted, usually used is a method that involves feeding them using an inert gas such as nitrogen and argon, hydrogen, ethylene, and so on in a state containing no solvent, or a method that involves dissolving or diluting the respective components in a solvent, and feeding them in a solution or slurry state.

When the prepolymerization is performed by the slurry polymerization method, a saturated aliphatic hydrocarbon compound is usually used as a solvent and examples thereof include propane, n-butane, isobutane, n-pentane, isopentane, n-hexane, cyclohexane, and heptane. These are used singly or two or more of them are used in combination. As the saturated aliphatic hydrocarbon compound, those having a boiling point at an ordinary pressure of 100° C. or lower are preferred, those having a boiling point at an ordinary pressure of 90° C. or lower are more preferred, and propane, n-butane, isobutane, n-pentane, isopentane, n-hexane, and cyclohexane are even more preferred.

When the prepolymerization is performed by the slurry polymerization method, as for the slurry concentration, the amount of the component (B) per liter of the solvent is usually 0.1 to 600 g, preferably 0.5 to 300 g. The prepolymerization temperature is usually −20 to 100° C., preferably 0 to 80° C. The polymerization temperature may be readily varied during the prepolymerization. The partial pressure of olefins in the vapor portion during the prepolymerization is usually 0.001 to 2 MPa, preferably 0.01 to 1 MPa. The prepolymerization time is usually 2 minutes to 15 hours.

Examples of the method for feeding the preliminarily polymerized prepolymerization solid catalyst component into a polymerization reaction vessel usually include a method that involves feeding them using an inert gas such as nitrogen and argon, hydrogen, ethylene, and so on in a state containing no moisture, and a method that involves dissolving or diluting the respective components in a solvent, and feeding them in a solution or slurry state.

The ethylene-α-olefin copolymer of the present invention may optionally contain known additives. Examples of such additives include antioxidants, weathering agents, lubricants, antiblocking agents, antistatic agents, anticlouding agents, antidripping agent, pigments, and fillers.

The ethylene-α-olefin copolymer of the present invention is formed by known processing techniques, such as extrusion processes, e.g., blown film process and flat die film process, blow molding, injection molding, and compression molding. The processing technique is preferably extrusion process or blow molding, and more preferably extrusion process.

The ethylene-α-olefin copolymer of the present invention is used by being shaped into various forms. The form of an article is not particularly restricted, and the molded article is used for films, sheets, containers (e.g., trays and bottles), and so on. The molded article is also used suitably for utilities such as food packaging materials, medicament packaging materials, electron parts packaging materials to be used for packaging semiconductor products, and surface protective materials.

As described above, the ethylene-α-olefin copolymer of the present invention is high in melt tension and swell ratio and also high in mechanical strength. Therefore, the processability in shaping is good. For example, neck-in in T-shaped die film forming can be reduced and the stability of a bubble in blown film molding can be increased. Resulting molded articles are superior in mechanical strength.

The mechanical strength, processability, optical characteristics, and so on of conventional ethylene-based polymers can be adjusted by blending a small amount of the ethylene-α-olefin copolymer of the present invention.

### EXAMPLES

The present invention is explained by reference to Examples and Comparative Examples below.

Physical properties in Examples and Comparative Examples were measured in accordance with the following methods.

(1) Density (d, Unit: kg/m³)

Measurement was conducted in accordance with the method provided in Method A. in JIS P7112-1980. Samples were subjected to the annealing disclosed in JIS K6760-1995.

(2) Melt Flow Rate (MFR, Unit: g/10 min)

Measurement was conducted by Method A under conditions represented by a load of 21.18 N and a temperature of 190° C. in accordance with the method provided in JIS K7210-1995.

### (3) Swell Ratio (SR)

A strand of an ethylene-α-olefin copolymer extruded in a length of around 15 to 20 mm through an orifice under conditions including a temperature of 190° C. and a load of 21.18 N in the measurement of the melt flow rate (2) was cooled in air, whereby a solid strand was obtained. Then, the diameter D (unit: mm) of the strand at a position of about 5 mm from the extrusion upstream side tip of the strand was measured and then a value (D/D₀) resulting from dividing the diameter D by the orifice diameter 2.095 mm (D₀) was calculated, and that value was used as a swell ratio.

### (4) Molecular Weight Distribution (Mw/Mn, Mz/Mw)

Using gel permeation chromatography (GPC) under the following conditions (1) through (8), a z average molecular weight (Mz), a weight average molecular weight (Mw) and a number average molecular weight (Mn) were measured, and then Mw/Mn and Mz/Mw were calculated. A straight line was defined as the baseline on the chromatogram, the straight line having been obtained by connecting a point within a stable horizontal region with retention times sufficiently shorter than the appearance of a sample elution peak and a point within a stable horizontal region with retention times sufficiently longer than the observance of a solvent elution peak.

(1) Instrument: Waters150C, manufactured by Waters

(2) Separation column: TOSOH TSKgel GMH6-HT

(3) Measurement temperature: 140° C.

(4) Carrier: orthodichlorobenzene

(5) Flow rate: 1.0 mL/min

(6) Injection amount: 500 μL.

(7) Detector: differential refraction

(8) Molecular weight standard substance: standard polystyrenes

(5) The Number of Branches Having 5 or More Carbon Atoms (N_{LCB}, Unit: 1/1000 C)

By the carbon nuclear magnetic resonance method under the following measurement conditions, a carbon nuclear magnetic resonance spectrum (¹³C-NMR) was measured, and the number of branches was determined by the following calculation method.

### <Measurement Conditions>

Instrument: AVANCE600 manufactured by Bruker

Measurement solvent: mixed solvent of 1,2-dichlorobenzene/1,2-dichlorobenzene-d4=75/25 (volumetric ratio)

Measurement temperature: 130° C.

Measurement method: proton decoupling method

Pulse width: 45 degrees

Pulse repetition time: 4 seconds

Measurement standard: trimethylsilane

Window function: negative exponential function

### <Calculation Method>

When the sum total of all peaks observed at 5 to 50 ppm was taken as 1000, the peak area of a peak having a peak top at around 38.22 to 38.27 ppm was determined. The peak area of the peak was defined by the area of a signal within a range from the chemical shift of a valley between the peak and a peak existing next thereto on the higher magnetic field side to the chemical shift of a valley between the peak and a peak existing next thereto on the lower magnetic field side. In the measurement of an ethylene-1-octene copolymer under the present conditions, the position of the peak top of a peak derived from methine carbon to which a branch having 6 carbon atoms was attached was 38.21 ppm.

(6) The Number of Short Chain Branches (N_{SCB}, Unit: 1/1000 C)

The number of short chain branches in an ethylene-α-olefin copolymer was determined from an infrared absorption spectrum. The measurement and calculation were conducted utilizing the characteristic absorption derived from an α-olefin in accordance with a method described in a document (Die Makromoleculare Chemie, 177, 449 (1976) McRae, M. A., Madams, W. F.). The infrared absorption spectrum was measured using an infrared spectrophotometer (FT-IR7300, manufactured by JASCO Corporation).

(7) g*

g* was calculated using the above-described formula (II).

[η] was determined by measuring the relative viscosity (ηrel) of an ethylene-α-olefin copolymer by the following method. A sample solution was prepared by dissolving at 135° C. 100 mg of the ethylene-α-olefin copolymer in 100 ml of tetralin containing 0.5% by weight of butylhydroxytoluene (BHT) as a thermal degradation inhibitor. Then, a fall time was measured for the sample solution and a blank solution consisting of a tetralin solution containing only 0.5% by weight of BHT as a thermal degradation inhibitor by the use of an Ubbelohde type viscometer, and an ηrel calculated from the results of the above measurement was substituted into the formula (II-I) and thus an [η] was calculated. [η]_{GPC} was calculated using formula (II-II) from (4) the measurement of the molecular weight distribution of an ethylene-α-olefin copolymer, and g_{SCB}* was calculated using formula (II-III) from (6) the measurement of the number of short chain branches of an ethylene-α-olefin copolymer.

(8) Melt Complex Viscosity (η*, Unit: Pa·sec)

Using a viscoelasticity measuring apparatus (Rheometrics Mechanical Spectrometer RMS-800 manufactured by Rheometrics) under the following measurement conditions, a melt complex viscosity-angular frequency curve at 190° C. was measured and then a melt complex viscosity measured at an angular frequency of 100 rad/sec was determined. The lower the melt complex viscosity, the lower the extrusion loading in extrusion and the better the processability.

### <Measurement Conditions>

Geometry: parallel plates

Plate diameter: 25 mm

Plate distance: 1.5 to 2 mm

Strain: 5%

Angular frequency: 0.1 to 100 rad/sec

Measurement atmosphere: nitrogen

(9) Activation Energy of Flow (Ea, Unit: kJ/mol)

Melt complex viscosity-angular frequency curves at 130° C., 150° C., 170° C., and 190° C. were measured under the following measurement conditions by using a viscoelasticity analyzer (Rheometrics Mechanical Spectrometer RMS-800 manufactured by Rheometrics), and then, from the resulting melt complex viscosity-angular frequency curves, a master curve of the melt complex viscosity-angular frequency curve at 190° C. was produced using calculation software Rhios V.4.4.4 produced by Rheometrics, whereby an Ea was determined.

### <Measurement Conditions>

Geometry: parallel plates

Plate diameter: 25 mm

Plate distance: 1.5 to 2 mm

Strain: 5%

Angular frequency: 0.1 to 100 rad/sec

Measurement atmosphere: nitrogen

### (10) Temperature Rising Elution Fractionation

Measurement was conducted under the following conditions using the following instrument.

Instrument: CFC T150A, manufactured by Mitsubishi Chemical Corporation

Detector: Magna-IR550, manufactured by Nicolet-Japan Corp.

Wavelength: data range 2982 to 2842 cm⁻¹

Column: UT-806M produced by Shows Denko K.K., 2 columns

Solvent: o-dichlorobenzene

Flow rate: 60 ml/hour

Sample concentration: 100 mg/25 ml

Sample injection: 0.8 ml

Loading conditions: Temperature was lowered from 140° C. to 0° C. at a rate of 1° C./min, followed by being left at rest for 30 minutes, and then elution was initiated from 0° C. fraction.

Conditions for taking data: Elution data were obtained at 0° C., 30° C., and 60° C. In the temperature range of 62° C. to 100° C., data of eluted amount were obtained at an interval of 2° C. up to at least 96° C. until no elution was observed, and subsequently the temperature was raised to 120° C. in the event that elution was detected at 100° C., and then data of eluted amount was obtained and analyzed.

(11) Impact Strength (Unit: kJ/m²)

Measurement was conducted in accordance with ASTM D1822-68.

### (12) Cold Xylene Soluble Fraction (CXS)

CXS was measured by the following method.

About 5 g of a polymer sample was dissolved in 1 liter of boiling xylene containing an antioxidant. The solution was cooled to room temperature over about 2 hours and then was left at rest at 25° C. for 20 hours. Thus, an insoluble fraction was precipitated. The solvent was removed from the filtrate collected by filtration and thereby the soluble fraction was taken out. CXS was determined by the correction of the soluble fraction taken out using the following formula.

Cold xylene-soluble fraction ratio=[[soluble fraction (g)×(1/volume of filtrate (liter))]/overall weight of polymer sample (5 g)]×100 (% by weight)

CXS is a convenient measure related to the stickiness of the surface of an article. It can be said that the lower the CXS is, the less sticky the surface of an article is.

### (13) Melt Tension (MT, Unit: cN)

Using a melt tension tester manufactured by Toyo Seiki Seisaku-sho, Ltd., an ethylene-α-olefin copolymer was melt-extruded through an orifice of 2.095 mm in diameter and 8 mm in length at a temperature of 190° C. and an extrusion rate of 0.32 g/min, and the extruded molten ethylene-α-olefin copolymer was taken-up into a filament shape at a take-up rising rate of 6.3 (m/min)/min with a taking-up roll, and a tension applied in taking-up was measured. The maximum tension during a period from the commencement of taking-up to the breakage of the filament-shaped ethylene-α-olefin copolymer was defined as melt tension.

### Example 1

### (1) Preparation of Component (B)

To a 50-liter, nitrogen-purged reactor equipped with a stirrer, 9.68 kg of silica (Sylopol 948 produced by Davison Corp; average particle diameter=55 μm; pore volume=1.67 ml/g; specific surface area=325 m²/g) thermally treated at 300° C. under a nitrogen flow as a solid state carrier for component (b) was charged. After the addition of 100 liters of toluene, the reactor was cooled to 2° C. To this, 26.3 liters of a toluene solution (2.9M) of methylalumoxane was dropped over one hour. After stirring at 5° C. for 30 minutes, the resultant was heated to 95° C. over 90 minutes, followed by stirring for 4 hours. Then, after cooling to 40° C., the resultant was left at rest for 40 minutes, thereby allowing a solid component to settle, and then the top slurry portion was removed. As a washing operation, 100 liters of toluene was added thereto, followed by stirring for 10 minutes, and then the stirring was stopped and the mixture was left at rest to allow a solid component to settle, and then the top slurry portion was likewise removed. The above-described washing operation was repeated three times in total. Moreover, 100 liters of toluene was added, followed by stirring, and then the stirring was stopped and simultaneously filtration was carried out. This operation was repeated once again. Hexane of 110 liters was added, followed by stirring, and then the stirring was stopped and simultaneously filtration was carried out. This operation was repeated once again. Then, the product collected by filtration was dried at 70° C. for 7 hours under nitrogen flow, affording 12.6 kg of component (B). Elemental analysis revealed that Al=4.4 mmol/g.

### (2) Preparation of Contact Mixture (X-1)

To a 200 ml glass eggplant flask flushed with nitrogen were added 4 g of the component (B) prepared in the above-described (1) and 50 ml of toluene, which were thereby slurried. Then, 11.4 ml of a toluene solution of bis(n-butylcyclopentadienyl)zirconium dichloride [corresponding to transition metal compound (A1)], the concentration of which had been adjusted to 2 μmol/ml, and 2.3 ml of a toluene solution of diphenylmethylene(cyclopentadienyl)(9-fluorenyl)zirconium dichloride [corresponding to transition metal compound (A2)], the concentration of which had been adjusted to 1 μmol/ml, were charged into a dropping funnel and mixed, and then the mixed liquid was dropped into the slurry within the eggplant flask over about 30 minutes under stirring. After the dropping, the eggplant flask containing the slurry of the mixture was moved into an oil bath of 80° C. to increase the temperature, and then a reaction was advanced for one hour. One hour later, the eggplant flask was taken out of the oil bath and allowed to air cool. Then, after the removal of the supernatant liquid by decantation, the product was washed twice with 50 ml of hexane, hexane was removed by decantation, and the resulting product was vacuum dried at room temperature for 2 hours, affording a powdery contact mixture (X-1).

### (3) Polymerization

An autoclave having an internal volume of 3 liters and equipped with a stirrer, the autoclave having been purged with argon after drying under reduced pressure, was evacuated, and then 230 ml of 1-hexene and 650 g of butane as a polymerization solvent were fed, and the temperature was raised to 70° C. Thereafter, ethylene gas was added so that the partial pressure of the gas might become 1.6 MPa, and the system was stabilized. Into this, 0.9 ml of a hexane solution of triisobutylaluminum as an organoaluminum compound (C), the concentration of which had been adjusted to 1 mol/l, was fed. Next, 44.3 mg of the powdery contact mixture (X-1) prepared in the above (2) was fed. During polymerization, while ethylene gas was supplied continuously, ethylene and 1-hexene were polymerized at 70° C. for 180 minutes. Then, butane and ethylene were purged, and 174 g of an ethylene-1-hexene copolymer was obtained. Physical properties of the resulting copolymer are shown in Table 1.

### Example 2

### (1) Polymerization

An autoclave having an internal volume of 3 liters and equipped with a stirrer, the autoclave having been purged with argon after drying under reduced pressure, was evacuated, hydrogen was added so that its partial pressure might become 0.004 MPa, and then 230 ml of 1-hexene and 650 g of butane as a polymerization solvent were fed, and the temperature was raised to 70° C. Thereafter, ethylene gas was added so that the partial pressure of ethylene gas might become 1.6 MPa, and the system was stabilized. Gas chromatography analysis found that the gas composition in the system was hydrogen=0.20 mol %. Into this, 0.9 ml of a hexane solution of triisobutylaluminum as an organoaluminum compound (C), the concentration of which had been adjusted to 1 mol/l, was fed. Next, 35.6 mg of the powdery contact mixture (X-1) prepared in Example 1(2) described above was fed. During polymerization, while ethylene gas was supplied continuously, ethylene and 1-hexene were polymerized at 70° C. for 180 minutes. Then, butane, ethylene, and hydrogen were purged, and 174 g of an ethylene-1-hexene copolymer was obtained. Physical properties of the resulting copolymer are shown in Table 1.

### Example 3

### (1) Preparation of Contact Mixture (X-2)

To a 200 ml glass eggplant flask flushed with nitrogen were added 4 g of the component (B) prepared in Example 1 (1) and 50 ml of toluene, which were thereby slurried. Then, 10.4 ml of a toluene solution of bis(n-butylcyclopentadienyl)zirconium dichloride [corresponding to transition metal compound (A1)], the concentration of which had been adjusted to 2 μmol/ml, and 4.1 ml of a toluene solution of diphenylmethylene(cyclopentadienyl)(9-fluorenyl)zirconium dichloride [corresponding to transition metal compound (A2)], the concentration of which had been adjusted to 1 μmol/ml, were charged into a dropping funnel and mixed, and then the mixed liquid was dropped into the slurry within the eggplant flask over about 30 minutes under stirring. After the dropping, the eggplant flask containing the slurry of the mixture was moved into an oil bath of 80° C. to increase the temperature, and then a reaction was advanced for one hour. One hour later, the eggplant flask was taken out of the oil bath and allowed to air cool. Then, after the removal of the supernatant liquid by decantation, the product was washed twice with 50 ml of hexane, hexane was removed by decantation, and the resulting product was vacuum dried at room temperature for 2 hours, affording a powdery contact mixture (X-2).

### (2) Polymerization

An autoclave having an internal volume of 3 liters and equipped with a stirrer, the autoclave having been purged with argon after drying under reduced pressure, was evacuated, and then 250 ml of 1-hexene and 650 g of butane as a polymerization solvent were fed, and the temperature was raised to 70° C. Thereafter, ethylene gas was added so that the partial pressure of the gas might become 1.6 MPa, and the system was stabilized. Into this, 0.9 ml of a hexane solution of triisobutylaluminum as an organoaluminum compound (C), the concentration of which had been adjusted to 1 mol/l, was fed. Next, 63.6 mg of the powdery contact mixture (X-2) prepared in the above (1) was fed. During polymerization, while ethylene gas was supplied continuously, ethylene and 1-hexene were polymerized at 70° C. for 90 minutes. Then, butane and ethylene were purged, and 230 g of an ethylene-1-hexene copolymer was obtained. Physical properties of the resulting copolymer are shown in Table 1.

### Example 4

### (1) Polymerization

An autoclave having an internal volume of 3 liters and equipped with a stirrer, the autoclave having been purged with argon after drying under reduced pressure, was evacuated, and then 250 ml of 1-hexene and 650 g of butane as a polymerization solvent were fed, and the temperature was raised to 70° C. Thereafter, ethylene gas was added so that the partial pressure of ethylene gas might become 1.6 MPa, and the system was stabilized. Into this, 0.9 ml of a hexane solution of triisobutylaluminum as an organoaluminum compound (C), the concentration of which had been adjusted to 1 mol/l, was fed. Next, 71.2 mg of the powdery contact mixture (X-2) prepared in Example 3(1) described above was fed. During polymerization, while ethylene/hydrogen mixed gas (hydrogen=0.075 mol %) was supplied continuously, ethylene and 1-hexene were polymerized at 70° C. for 80 minutes. Then, butane, ethylene, and hydrogen were purged, and 257 g of an ethylene-1-hexene copolymer was obtained. Physical properties of the resulting copolymer are shown in Table 1.

### Example 5

### (1) Polymerization

An autoclave having an internal volume of 3 liters and equipped with a stirrer, the autoclave having been purged with argon after drying under reduced pressure, was evacuated, hydrogen was added so that its partial pressure might become 0.002 MPa, and then 250 ml of 1-hexene and 650 g of butane as a polymerization solvent were fed, and the temperature was raised to 70° C. Thereafter, ethylene gas was added so that the partial pressure of ethylene gas might become 1.6 MPa, and the system was stabilized. Gas chromatography found that the gas composition in the system was hydrogen=0.058 mol %. Into this, 0.9 ml of a hexane solution of triisobutylaluminum as an organoaluminum compound (C), the concentration of which had been adjusted to 1 mol/l, was fed. Next, 71.2 mg of the powdery contact mixture (X-2) prepared in Example 3(1) described above was fed. During polymerization, while ethylene/hydrogen mixed gas (hydrogen=0.11 mol %) was supplied continuously, ethylene and 1-hexene were polymerized at 70° C. for 60 minutes. Then, butane, ethylene, and hydrogen were purged, and 284 g of an ethylene-1-hexene copolymer was obtained. Physical properties of the resulting copolymer are shown in Table 1.

### Example 6

### (1) Preparation of Contact Mixture (X-3)

To a 200 ml glass eggplant flask flushed with nitrogen were added 4 g of the component (B) prepared in Example 1 (1) and 50 ml of toluene, which were thereby slurried. Then, 8.4 ml of a toluene solution of bis(n-butylcyclopentadienyl)zirconium dichloride [corresponding to transition metal compound (A1)], the concentration of which had been adjusted to 2 μmol/ml, and 8.3 ml of a toluene solution of diphenylmethylene(cyclopentadienyl)(9-fluorenyl)zirconium dichloride [corresponding to transition metal compound (A2)], the concentration of which had been adjusted to 1 μmol/ml, were charged into a dropping funnel and mixed, and then the mixed liquid was dropped into the slurry within the eggplant flask over about 30 minutes under stirring. After the dropping, the eggplant flask containing the slurry of the mixture was moved into an oil bath of 80° C. to increase the temperature, and then a reaction was advanced for one hour. One hour later, the eggplant flask was taken out of the all bath and allowed to air cool. Then, after the removal of the supernatant liquid by decantation, the product was washed twice with 50 ml of hexane, hexane was removed by decantation, and the resulting product was vacuum dried at room temperature for 2 hours, affording a powdery contact mixture (X-3).

### (2) Polymerization

An autoclave having an internal volume of 3 liters and equipped with a stirrer, the autoclave having been purged with argon after drying under reduced pressure, was evacuated, hydrogen was added so that its partial pressure might become about 0.002 MPa, and then 180 ml of 1-hexene and 650 g of butane as a polymerization solvent were fed, and the temperature was raised to 70° C. Thereafter, ethylene gas was added so that the partial pressure of the gas might become 1.6 MPa, and the system was stabilized. Gas chromatography found that the gas composition in the system was hydrogen=0.072 mol %. Into this, 0.9 ml of a hexane solution of triisobutylaluminum as an organoaluminum compound (C), the concentration of which had been adjusted to 1 mol/l, was fed. Next, 53.4 mg of the powdery contact mixture (X-3) prepared in the above (1) was fed. During polymerization, while ethylene gas was supplied continuously, ethylene and 1-hexene were polymerized at 70° C. for 60 minutes. Then, butane, ethylene, and hydrogen were purged, and 149 g of an ethylene-1-hexene copolymer was obtained. Physical properties of the resulting copolymer are shown in Table 1.

### Example 7

### (1) Polymerization

An autoclave having an internal volume of 3 liters and equipped with a stirrer, the autoclave having been purged with argon after drying under reduced pressure, was evacuated, hydrogen was added so that its partial pressure might become about 0.002 MPa, and then 180 ml of 1-hexene and 650 g of butane as a polymerization solvent were fed, and the temperature was raised to 70° C. Thereafter, ethylene gas was added so that the partial pressure of the gas might become 1.6 MPa, and the system was stabilized. Gas chromatography found that the gas composition in the system was hydrogen=0.060 mol %. Into this, 0.9 ml of a hexane solution of isobutylaluminum as an organoaluminum compound (C), the concentration of which had been adjusted to 1 mol/l, was fed. Next, 53.1 mg of the powdery contact mixture (X-3) prepared in Example 7(1) described above was fed. During polymerization, while ethylene/hydrogen mixed gas (hydrogen=0.042 mol %) was supplied continuously, ethylene and 1-hexene were polymerized at 70° C. for 60 minutes. Then, butane, ethylene, and hydrogen were purged, and 147 g of an ethylene-1-hexene copolymer was obtained. Physical properties of the resulting copolymer are shown in Table 2.

### Example 8

### (1) Polymerization

An autoclave having an internal volume of 3 liters and equipped with a stirrer, the autoclave having been purged with argon after drying under reduced pressure, was evacuated, and then 180 ml of 1-hexene and 650 g of butane as a polymerization solvent were fed, and the temperature was raised to 70° C. Thereafter, ethylene gas was added so that the partial pressure of the gas might become 1.6 MPa, and the system was stabilized. Into this, 0.9 ml of a hexane solution of triisobutylaluminum as an organoaluminum compound (C), the concentration of which had been adjusted to 1 mol/l, was fed. Next, 38.0 mg of the powdery contact mixture (X-3) prepared in Example 7(1) described above was fed. During polymerization, while ethylene gas was supplied continuously, ethylene and 1-hexene were polymerized at 70° C. for 60 minutes. Then, butane and ethylene were purged, and 74 g of an ethylene-1-hexene copolymer was obtained. Physical properties of the resulting copolymer are shown in Table 2.

### Example 9

### (1) Preparation of Contact Mixture (X-4)

To a 200 ml glass eggplant flask flushed with nitrogen were added 4 g of the component (B) prepared in Example 1 (1) and 50 ml of toluene, which were thereby slurried. Then, 4.9 ml of a toluene solution of bis(n-butylcyclopentadienyl)zirconium dichloride [corresponding to transition metal compound (A1)], the concentration of which had been adjusted to 5 μmol/ml, and 36.9 ml of a toluene solution of diphenylmethylene(cyclopentadienyl)(9-fluorenyl)zirconium dichloride [corresponding to transition metal compound (A2)], the concentration of which had been adjusted to 2 μmol/ml, were charged into a dropping funnel and mixed, and then the mixed liquid was dropped into the slurry within the eggplant flask over about 30 minutes under stirring. After the dropping, the eggplant flask containing the slurry of the mixture was moved into an oil bath of 80° C. to increase the temperature, and then a reaction was advanced for one hour. One hour later, the eggplant flask was taken out of the oil bath and allowed to air cool. Then, after the removal of the supernatant liquid by decantation, the product was washed twice with 50 ml of hexane, hexane was removed by decantation, and the resulting product was vacuum dried at room temperature for 2 hours, affording a powdery contact mixture (X-4).

### (2) Polymerization

An autoclave having an internal volume of 3 liters and equipped with a stirrer, the autoclave having been purged with argon after drying under reduced pressure, was evacuated, hydrogen was added so that its partial pressure might become about 0.002 MPa, and then 180 ml of 1-hexene and 650 g of butane as a polymerization solvent were fed, and the temperature was raised to 70° C. Thereafter, ethylene gas was added so that the partial pressure of the gas might become 1.6 MPa, and the system was stabilized. Gas chromatography found that the gas composition in the system was hydrogen=0.07 mol %. Into this, 0.9 ml of a hexane solution of triisobutylaluminum as an organoaluminum compound (C), the concentration of which had been adjusted to 1 mol/l, was fed. Next, 58.7 mg of the powdery contact mixture (X-4) prepared in the above (1) was fed. During polymerization, while ethylene/hydrogen mixed gas (hydrogen=0.09 mol %) was supplied continuously, ethylene and 1-hexene were polymerized at 70° C. for 60 minutes. Then, butane, ethylene, and hydrogen were purged, and 211 g of an ethylene-1-hexene copolymer was obtained. Physical properties of the resulting copolymer are shown in Table 2.

### Comparative Example 1

### (1) Polymerization

An autoclave having an internal volume of 3 liters and equipped with a stirrer, the autoclave having been purged with argon after drying under reduced pressure, was evacuated, and then 250 ml of 1-hexene and 650 g of butane as a polymerization solvent were fed, and the temperature was raised to 70° C. Thereafter, ethylene gas was added so that the partial pressure of the gas might become 1.6 MPa, and the system was stabilized. Into this, 0.9 ml of a hexane solution of triisobutylaluminum as an organoaluminum compound (C), the concentration of which had been adjusted to 1 mol/l, was fed. Then, 1.5 ml of a toluene solution of bis(n-butylcyclopentadienyl)zirconium dichloride [corresponding to transition metal compound (A1)], the concentration of which had been adjusted to 1 μmol/ml, and 0.3 ml of a toluene solution of diphenylmethylene(cyclopentadienyl)(9-fluorenyl)zirconium dichloride [corresponding to transition metal compound (A2)], the concentration of which had been adjusted to 1 μmol/ml, were fed and, subsequently 74 mg of the solid catalyst component obtained in Example 1(1) was fed therein. During polymerization, while ethylene/hydrogen mixed gas (hydrogen=0.083 mol %) was supplied continuously, ethylene and 1-hexene were polymerized at 70° C. for 80 minutes. Then, butane, ethylene, and hydrogen were purged, and 185 g of an ethylene-1-hexene copolymer was obtained. Physical properties of the resulting copolymer are shown in Table 2.

### Comparative Example 2

### (1) Preparation of Contact Mixture (X-5)

To a 200 ml glass eggplant flask flushed with nitrogen were added 4 g of the component (B) prepared in Example 1 (1) and 50 ml of toluene, which were thereby slurried. Then, 18.6 ml of a toluene solution of bis(n-butylcyclopentadienyl)zirconium dichloride [corresponding to transition metal compound (A1)], the concentration of which had been adjusted to 5 μmol/ml, and 1.2 ml of a toluene solution of diphenylmethylene(cyclopentadienyl)(9-fluorenyl)zirconium dichloride [corresponding to transition metal compound (A2)], the concentration of which had been adjusted to 2 μmol/ml, were charged into a dropping funnel and mixed, and then the mixed liquid was dropped into the slurry within the eggplant flask over about 30 minutes under stirring. After the dropping, the eggplant flask containing the slurry of the mixture was moved into an oil bath of 80° C. to increase the temperature, and then a reaction was advanced for one hour. One hour later, the eggplant flask was taken out of the oil bath and allowed to air cool. Then, after the removal of the supernatant liquid by decantation, the product was washed twice with 50 ml of hexane, hexane was removed by decantation, and the resulting product was vacuum dried at room temperature for 2 hours, affording a powdery contact mixture (X-5).

### (2) Polymerization

An autoclave having an internal volume of 3 liters and equipped with a stirrer, the autoclave having been purged with argon after drying under reduced pressure, was evacuated, and then 280 ml of 1-hexene and 650 g of butane as a polymerization solvent were fed, and the temperature was raised to 70° C. Thereafter, ethylene gas was added so that the partial pressure of the gas might become 1.6 MPa, and the system was stabilized. Into this, 0.9 ml of a hexane solution of triisobutylaluminum as an organoaluminum compound (C), the concentration of which had been adjusted to 1 mol/l, was fed. Next, 55.7 mg of the powdery contact mixture (X-5) prepared in the above (1) was charged, and then ethylene and 1-hexene were polymerized at 70° C. for 120 minutes. Then, butane and ethylene were purged, and 180 g of an ethylene-1-hexene copolymer was obtained. Physical properties of the resulting copolymer are shown in Table 2.

TABLE 1

| | | Example 1 | Example 2 | Example 3 | Example 4 | Example 5 | Example 6 |
|---|---|---|---|---|---|---|---|
| Density | kg/m³ | 924 | 927 | 919 | 921 | 922 | 923 |
| MFR | g/10 min | 0.9 | 2.4 | 0.8 | 3.1 | 7.1 | 1.0 |
| SR | — | 2.42 | 2.60 | 2.43 | 2.43 | 2.49 | 2.60 |
| Molecular | | | | | | | |
| weight | | | | | | | |
| distribution | | | | | | | |
| Mw/Mn | — | 3.1 | 3.4 | 2.7 | 2.7 | 3.0 | 2.9 |
| Mz/Mw | | 3.6 | 3.3 | 2.9 | 3.1 | 3.3 | 3.5 |
| N_{LCB} | 1/1000 C | <0.05 | <0.05 | <0.05 | <0.05 | <0.05 | <0.05 |
| N_{SCB} | 1/1000 C | 11.5 | 10.1 | 12.9 | 14.3 | 15.2 | 10.9 |
| [η] | | 1.60 | 1.39 | 1.66 | 1.31 | 1.14 | 1.60 |
| g* | — | 0.89 | 0.91 | 0.91 | 0.92 | 0.91 | 0.93 |
| Melt tension | cN | 17.0 | 8.2 | 14.7 | 5.2 | 2.7 | 26.0 |
| Impact | kJ/m² | 1382 | 921 | 1770 | 1325 | 1073 | 1364 |
| strength | | | | | | | |
| The number of | peak(s) | | | 2 | 2 | 2 | 2 |
| elution peaks | | | | | | | |
| (temperature | | | | | | | |
| rising elution | | | | | | | |
| fractionation) | | | | | | | |
| Elution peak | ° C. | | | 76, 88 | 76, 86 | 76, 84 | 78, 88 |
| temperature | | | | | | | |
| Mw(H) | x100 | | | 504 | 559 | 494 | 516 |
| Mw(L) | x100 | | | 875 | 902 | 655 | 807 |
| H/L | — | | | 2.2 | 1.5 | 1.1 | 3.1 |
| Elution rate at | % | | | <0.1 | <0.1 | <0.1 | <0.1 |
| temperatures | | | | | | | |
| equal to or | | | | | | | |
| higher than | | | | | | | |
| 96° C. | | | | | | | |
| Elution rate at | % | | | 7.9 | 10.9 | 11.7 | 6.5 |
| temperatures | | | | | | | |
| equal to or | | | | | | | |
| lower than 60° C. | | | | | | | |
| Melt complex | Pa · sec | 1448 | 1026 | 1795 | 891 | 569 | 1459 |
| viscosity | | | | | | | |
| CXS | % | 2.1 | 1.6 | 2.0 | 2.2 | 2.1 | 2.2 |
| Activation | kJ/mol | 33.3 | 31.5 | 34.6 | 34.5 | 34.0 | 31.3 |
| energy of flow | | | | | | | |

*A blank indicates that no measurement was conducted.

TABLE 2

| | | | | | Comparative | Comparative |
|---|---|---|---|---|---|---|
| | | Example 7 | Example 8 | Example 9 | Example 1 | Example 2 |
| Density | kg/m³ | 923 | 921 | 923 | 924 | 923 |
| MFR | g/10 min | 1.3 | 0.44 | 2.1 | 3.5 | 2.2 |
| SR | — | 2.60 | 2.30 | 2.41 | 1.74 | 1.42 |
| Molecular | | | | | | |
| weight | | | | | | |
| distribution | | | | | | |
| Mw/Mn | — | 2.7 | 3.0 | 3.4 | 2.8 | 2.2 |
| Mz/Mw | | 3.6 | 3.3 | 4.1 | 2.5 | 1.9 |
| N_{LCB} | 1/1000 C. | <0.05 | <0.05 | <0.05 | <0.05 | <0.05 |
| N_{SCB} | 1/1000 C. | 11.7 | 12.6 | 14.8 | 9.1 | 11.3 |
| [η] | | 1.52 | 1.82 | 1.38 | 1.33 | 1.49 |
| g* | — | 0.91 | 0.93 | 1 | 0.92 | 1 |
| Melt tension | cN | 19.7 | 20.7 | 10.5 | 1.6 | 1.5 |
| Impact | kJ/m² | 1346 | 1611 | 1094 | 1213 | 1557 |
| strength | | | | | | |
| The number of | peak(s) | 2 | 2 | | 1 | |
| elution peaks | | | | | | |
| (temperature | | | | | | |
| rising elution | | | | | | |
| fractionation) | | | | | | |
| Elution peak | ° C. | 80, 88 | 76, 88 | | 86 | |
| temperature | | | | | | |
| Mw(H) | ×100 | 677 | 1009 | | — | |
| Mw(L) | ×100 | 1025 | 1788 | | — | |
| H/L | — | 2.8 | 3.2 | | — | |
| Elution rate at | % | <0.1 | <0.1 | <0.1 | <0.1 | <0.1 |
| temperatures | | | | | | |
| equal to or | | | | | | |
| higher than 96° C. | | | | | | |
| Elution rate at | % | 6.9 | 7.4 | 11.3 | 7.2 | 7.0 |
| temperatures | | | | | | |
| equal to or | | | | | | |
| lower than 60° C. | | | | | | |
| Melt complex | Pa · sec | 1176 | 1805 | 606 | 993 | 1565 |
| viscosity | | | | | | |
| CXS | % | 2.6 | 3.1 | 5.5 | 0.5 | 0.4 |
| Activation | kJ/mol | 33.0 | 32.7 | 32.4 | 33.3 | 31.7 |
| energy of flow | | | | | | |

*A blank indicates that no measurement was conducted.

### INDUSTRIAL APPLICABILITY

The present invention can afford an ethylene-α-olefin copolymer high in melt tension and swell ratio and also high in mechanical strength, and an article obtained by extruding the copolymer.

1. An ethylene-α-olefin copolymer comprising monomer units derived from ethylene and monomer units derived from an α-olefin having 3 to 20 carbon atoms, wherein the ethylene-α-olefin copolymer has a density of 860 to 950 kg/m³, a melt flow rate of 0.1 to 20.0 g/10 minutes, a ratio of a weight average molecular weight to a number average molecular weight measured by gel permeation chromatography of 2.0 to 3.5, a swell ratio of 2.0 to 2.8, and an activation energy of flow of 31.0 to 35.0 kJ/mol.

2. An article obtained by extruding the ethylene-α-olefin copolymer according to claim 1.
